(19) United States
(12) Patent Application Publication
(10) Pub. No.: US 2025/0085131 A1
(43) Pub. Date: Mar. 13, 2025

(54) GENERATIVE ARTIFICIAL INTELLIGENCE PROMPT CREATION, SMART INFORMATION INTEGRATION, AND APPLICATION OF RESULTANT ARTIFACTS FOR NAVIGATION AND ENHANCED CONTENT GENERATION

(71) Applicant: Adeia Guides Inc., San Jose, CA (US)

(72) Inventors: Charles Dasher, Lawrenceville, GA (US); Christopher Phillips, Hartwell, GA (US); Reda Harb, Tampa, FL (US)

(21) Appl. No.: 18/244,518

(22) Filed: Sep. 11, 2023

(51) Int. Cl. G01C 21/36; G06T 7/60; G06T 19/00; G06V 20/13; G10L 15/183; G10L 15/22

(52) U.S. Cl. CPC G01C 21/3626; G06T 7/60; G06T 19/00; G06V 20/13; G10L 15/183; G10L 15/22; G06T 2207/10032

(57) ABSTRACT

Methods and systems are described for automatic content generation, imaging, and navigation. Inputs including mapping data, original imagery, live information, and user-generated information are received. The inputs are processed to generate prompts as an intermediate output. The inputs and the generated prompts are input into generative AI systems. The output of the generative AI systems is integrated into enhanced images, enhanced maps, and enhanced directions along a route. Artificial intelligence systems, including neural networks, and models are utilized to improve the automatic content generation, imaging, and navigation. Related apparatuses, devices, techniques, and articles are also described.

### FIELD OF THE INVENTION

The present disclosure relates to automatic content generation, imaging, and navigation.

### SUMMARY

Real-time live satellite imagery is not available to the general public. As such, some mapping applications rely on a collection of static images taken by satellites. The resulting maps are relatively uninformative.

In generative artificial intelligence (AI), OpenAI and MidJourney use natural language processing (NLP) to create data required for input into their respective systems. For example, OpenAI's ChatGPT utilizes a question-and-answer prompt, and MidJourney utilizes an image processing prompt. These systems generate various types of content such as audio content, image content, video content, and textual content based on general language processing. With such AI systems, particularly those based on NLP, a prompt serves as an input or a starting point for the AI model to generate an appropriate response or output. Prompts are simple queries, complex questions, statements, or partial sentences that are input into the AI model. The AI model generates output based on the prompts. However, interpretations of prompts vary from platform to platform and require a user to learn best practices and conventions for each particular platform, which is neither intuitive nor user friendly. As such, prompt-based systems, which are user facing, represent a cumbersome first step in generating subsequent content.

Google Earth displays representations of weather events, such as clouds on a map with animations. Weather satellites use sensors to detect clouds. A map of the clouds is converted into an image, which Google Earth integrates into maps for display. However, the cloud imagery is simplistic.

Google launched a demonstration version of a Maps Immersive View with changes based on predicted weather conditions. Again, Google simplistically adds three-dimensional (3D) models of vehicles to maps and moves the rendered vehicles along a route in a manner similar to adding 3D objects to a 3D environment. Google Maps uses traffic data to control a density (a number) of objects placed and a speed at which the objects move along the route. However, Google Maps does not integrate satellite imagery. Google Maps Immersive View does not work in areas where a 3D model of the region was not previously generated. Google's existing 3D maps are provided for relatively large metropolitan areas and nearby surrounding regions. Google Maps Immersive View does not incorporate ambient sound. For example, Google Maps Immersive View depicts a rain event as a general overlay (as if one were looking through rain). The depicted rain does not affect an appearance of 3D objects in the view.

To overcome these and other problems, improved mapping applications and enhanced content generation are provided. In some embodiments, in an integrated manner, one or more inputs including at least one of mapping data (such as driving directions), original imagery (such as maps, photos from real estate tax records, mapping application output, user-provided imagery, and the like), live information (such as live traffic, live weather, information about live events, and the like), user-generated information (such as user selections, locations of a user's device, user search queries, user selection of a zoom level, and the like), combinations of the same, or the like, are received. The inputs are processed to generate prompts as an intermediate output in some embodiments. The input and/or the generated prompts are input into one or more generative AI systems (such as at least one of a large language model (LLM), a generative image system, a trained model and/or system of the LLM or generative image system, combinations of the same, or the like). The output of the one or more generative AI systems is integrated into enhanced images, enhanced maps, enhanced directions along a route, and the like. Thus, a search for a business results in an enhanced image, audio, or video of the business with live information pertinent to the business. Also, a search for a property results in an enhanced image, audio, or video of the property updated to include a likely current appearance. Further, a search for driving directions triggers pre-processing so that enhanced imagery, audio, or video is generated in real time as the user progresses along the route.

The present invention is not limited to the combination of the elements as listed herein and may be assembled in any combination of the elements as described herein.

These and other capabilities of the disclosed subject matter will be more fully understood after a review of the following figures, detailed description, and claims.

### BRIEF DESCRIPTIONS OF THE DRAWINGS

The present disclosure, in accordance with one or more various embodiments, is described in detail with reference to the following figures. The drawings are provided for purposes of illustration only and merely depict non-limiting examples and embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings, in which like reference numerals indicate identical or functionally similar elements, of which:

FIG. 1A depicts a system for utilizing generative AI to create prompts, integrate information, and apply resultant artifacts to generate navigation audiovisual content and to, more generally, generate enhanced audiovisual content, in accordance with some embodiments of the disclosure;

FIG. 1B depicts a user-system dialog and a resulting enhanced map image including live weather data, in accordance with some embodiments of the disclosure;

FIG. 1C depicts a user-system dialog and a resulting enhanced map image including live cell phone tracking data, in accordance with some embodiments of the disclosure;

FIG. 1D depicts a user-system dialog and a resulting enhanced business image including live information relevant to the depicted business, in accordance with some embodiments of the disclosure;

FIG. 1E depicts a user-system dialog and a resulting enhanced street view image of a business including live weather, building, and traffic information relevant to the depicted business, in accordance with some embodiments of the disclosure;

FIG. 2 is a flowchart of a process for generating a user interface, a prompt, content, and a map layer update, in accordance with some embodiments of the disclosure;

FIG. 3 is a flowchart of a process for adding location information and point of interest (POI) information to a prompt, generating a prompt from inputs, generating text and/or audio and/or video, and adding generated text and/or audio and/or video to a map layer, in accordance with some embodiments of the disclosure;

FIG. 4 is a flowchart of process for adding a map image and location information to a prompt, adding POI information, adding external data, generating a prompt from inputs, generating an overlap image from the prompt, and adding the generated image to a map layer, in accordance with some embodiments of the disclosure;

FIG. 5A depicts a map image of a POI from a mapping application, in accordance with some embodiments of the disclosure;

FIG. 5B depicts the map image of the POI from the mapping application with an overlay based on weather data, in accordance with some embodiments of the disclosure;

FIG. 6A depicts a map image of the POI from a mapping application at a higher zoom level (compared to FIG. 5A), in accordance with some embodiments of the disclosure;

FIG. 6B depicts the map image of the POI from the mapping application at the higher zoom level with an overlay based on weather data, in accordance with some embodiments of the disclosure;

FIG. 7A depicts a 3D map image of a business from a mapping application, in accordance with some embodiments of the disclosure;

FIG. 7B depicts a 2D map image of the business from the mapping application, in accordance with some embodiments of the disclosure;

FIG. 7C depicts the 2D map image of the business from the mapping application with additional objects (e.g., a long line of cars in drive-through lanes) rendered in a raster layer added to the map image, in accordance with some embodiments of the disclosure;

FIG. 7D depicts the 2D map image of the business from the mapping application with the additional objects rendered in the raster layer added to the map image and with another layer including weather data (e.g., clouds), in accordance with some embodiments of the disclosure;

FIG. 7E depicts the 2D map image of the business from the mapping application with the additional objects rendered in the raster layer added to the map image, with another layer including the weather data, and with a further layer including a rendered environmental effect (e.g., wet pavement), in accordance with some embodiments of the disclosure;

FIG. 8A depicts a 3D map image of a location from a mapping application, in accordance with some embodiments of the disclosure;

FIG. 8B depicts the 3D map image of the location from the mapping application with an overlay based on weather data and with rendered objects (e.g., a car and a truck) based on a prompt, in accordance with some embodiments of the disclosure;

FIG. 8C depicts a selected portion of FIG. 8A, in accordance with some embodiments of the disclosure;

FIG. 8D depicts a selected portion of FIG. 8B, in accordance with some embodiments of the disclosure;

FIG. 9 is a flowchart of process for determining a proximity from a route selection; sending maps labels, POIs, and other candidates for AI generation to an AI prompt generation system; and adding resulting objects to one or more map layers, in accordance with some embodiments of the disclosure;

FIG. 10A depicts a map image of a route selection in a mapping application with an area corresponding to a determined proximity from the route highlighted on the map image, in accordance with some embodiments of the disclosure;

FIG. 10B depicts an enhanced street view including an overlay representing a path according to turn-by-turn navigation, in accordance with some embodiments of the disclosure;

FIG. 11 is a flowchart of process for generating AI prompts, sending the prompts to one or more generative AI systems, and updating a map image from a mapping application with the generated outputs, in accordance with some embodiments of the disclosure;

FIG. 12 is a flowchart of a process for automatically playing generated audio added to output from a mapping application, in accordance with some embodiments of the disclosure;

FIG. 13A depicts a street view image of a business adjusted in real time through AI prompting, in accordance with some embodiments of the disclosure;

FIG. 13B depicts the street view image adjusted in real time through the AI prompting at a different point in time (e.g., at night), in accordance with some embodiments of the disclosure;

FIG. 14A depicts a street view image of a location from a mapping application from the year 2011, in accordance with some embodiments of the disclosure;

FIG. 14B depicts a satellite image of the location from the mapping application from the year 2022, in accordance with some embodiments of the disclosure;

FIG. 14C depicts the street view image of the location from the mapping application updated via AI prompting with the street view image and the satellite image as inputs along with time of day, temperature, season, and the like (e.g., a depiction of the location in current time), in accordance with some embodiments of the disclosure;

FIG. 14D depicts a satellite image of a location from a mapping application, wherein a street view of the location does not exist, in accordance with some embodiments of the disclosure;

FIG. 14E depicts a first photograph of the location from a tax record associated with the location from the year 2009, in accordance with some embodiments of the disclosure;

FIG. 14F depicts a second photograph of the location from the tax record associated with the location from the year 2009, in accordance with some embodiments of the disclosure;

FIG. 14G depicts a generated street view image of the location leveraging generative AI for depicting weather, the season, a time of day, the satellite imagery, the tax record information, and rendered changes over time from a date of the original imagery to a present date for each portion of the street view image with adjustments to objects (e.g., plant growth) based on the changes over time, in accordance with some embodiments of the disclosure;

FIG. 15A depicts a map image of a business from a mapping application with an overlay of rendered objects (e.g., two vehicles rounding a corner), in accordance with some embodiments of the disclosure;

FIG. 15B depicts the map image of the business from the mapping application with the overlay of the rendered objects and after application of pixelation and/or resolution data, in accordance with some embodiments of the disclosure;

FIG. 15C depicts a portion of the map image of the business from the mapping application with the overlay of the rendered objects, in accordance with some embodiments of the disclosure;

FIG. 15D depicts the portion of the map image of the business from the mapping application with the overlay of the rendered objects and with a rendered shadow for the objects, in accordance with some embodiments of the disclosure;

FIG. 16 depicts a predictive model for generating content, in accordance with some embodiments of the disclosure; and

FIG. 17 depicts a system including a server, a communication network, and a computing device for performing the methods and processes noted herein, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting embodiments and that the scope of the present invention is defined solely by the claims.

### DETAILED DESCRIPTION

An enhanced experience is provided in which generative AI is used to generate, for example, a map or view of an object or thing that is enhanced with real-time information, imagery, and the like. AI and related computational processes generate content automatically and on-demand. Mobile, automotive, and navigational implementations are provided. Maps, street views, and 3D renderings are enhanced to simulate a live view of an object or place and provide a more meaningful user experience.

In some embodiments, instead of tasking a user with creating a prompt suitable for a generative AI system, a relatively simple text and/or voice query initiates the enhancement process. Depending on the context of the query, an enhanced prompt is electronically generated, moderated, reviewed for quality, and input into one or more AI systems. Mapping applications are utilized in some embodiments to generate one or more prompts (or inputs) as intermediate outputs, which are then utilized for processing original images (e.g., satellite images) within mapping applications to additively alter the images based on the data inputs. A prompt or query is received by the AI system in some embodiments, and the prompt or query is broken down into smaller parts or sub-steps. The smaller parts or sub-steps are selected and input into one or more tools of the AI system (e.g., web search, image generation, audio generation, video generation, and the like). The tools are assigned to the prompt, which is acting as an agent. The prompt (acting as the agent) is iteratively looped, in some embodiments, over smaller parts. The looped responses are used as input into other queries. The examples herein cover an overall system architecture for query-to-prompt conversion, incorporation of various types of inputs and information, generation of prompts, generation of content, analysis of objects, and integration of intermediate output into a final format for output.

LLM agents are prompted with contextual data in some embodiments. The contextual data is provided by a mapping application and by searching for related information within a context of a location on a map. The contextual data is determined through user selection, user location search or a zoom to location performed by a user. AI prompts are created for various types of generative AI systems, such as a generative audio system for creating ambient sounds related to the map point location, a generative AI imaging system to add additional visual elements (such as traffic overlays on a satellite map, which appear as photorealistic images of cars, trucks, construction zones, line wait times at drive-through restaurants, and the like) as well as real-time descriptions of events (e.g., sourced from localized data sources such as a carnival or sporting event). In this way, a more immersive and interactive user experience is achieved, offering a richer and more contextually relevant presentation of geospatial information within a mapping application.

In some embodiments, prompts are dynamically generated. The prompts are personalized and context-aware. The prompts result in output (e.g., audio output, different pictures, and the like) that is dynamic and does not persist. More specifically, dynamic prompts are generated based on location of a moving object (e.g., car), a projected path of the moving object (e.g., based on start and/or destination addresses), and other contexts (e.g., weather, traffic, metadata specific to a POI such as wait time, popular times, and the like).

AI prompts are generated for various types of generative AI systems, such as generative audio, video, and/or imaging systems. The prompts are derived from contextual data. The context data is derived from mapping applications considering information, such as at least one of map location data, embedded map POI data, external data such as weather or traffic data, data learned from map POI data (for example, by reading a URL embedded into POI data, by following links, and by summarizing the information), combinations of the same, or the like. For embodiments including a generative video system, the system is configured to generate a sequence of images, e.g., navigation images and direction overlays. The sequence of images is updated, for example, based on a vehicle speed, other navigational information, combinations of the same, or the like. The sequence of images is adjusted based on available bandwidth in some embodiments. The sequence of images is encoded as video and sent to an output device for a navigational overlay.

AI prompts are re-generated and prompts are processed in various generative AI systems. In some embodiments, the re-generating and the processing occur autonomously during a trip (e.g., driving directions). Prompts are created on a region of a map that corresponds to a current location of a traveler. The method and the system are configured to pre-process information for upcoming regions, which are located in or around geographical points of the driving route.

Base maps are enhanced by incorporating additional content like auditory information and visual elements into various mapping layers and updating the data to create an illusion of movement. That is, for example, a sequence of images is generated and encoded as video to create the illusion of movement. For example, photo realistic images of traffic are generated with AI. In some embodiments, a user enters a make and model of their personal vehicle (and related details such as year of manufacture, color, and the like) and/or uploads an image of the user's vehicle. As such, images generated by the system include images of the user's vehicle.

In some embodiments, the generated AI prompts are configured to generate output based on at least one of user preferences, a viewport (i.e., a user's visible area of a screen, also known as a polygon viewing region) of a display device, a 3D tilt mode, a viewing angle, a zoom level, combinations of the same, or the like.

Enhanced output is generated including topographical elements like basins, mountain ranges, deserts, and other landforms for comprehensive geographic information. For example, weather data indicates snowfall. In response, the AI generation system is configured to display snow on a mountain differently than snow on a road.

Instructions suitable for generative AI systems are generated. The instructions are configured to create objects suitable for integration into specific map layers based on prompts also generated by the methods and systems.

Enhanced driving instructions are generated. During a driving directions session, the system is configured to autonomously seek out and create visual objects to add to layers and descriptive text that is added to map layers, converted to speech, and read aloud during a trip. The driving directions session is enhanced with AI-generated ambient sounds associated with the current area or region in which the traveler is currently located.

In some embodiments, prompts for AI systems are generated to create realistic street view images in situations when such images did not previously exist with an appearance that simulates a live and/or real-time view.

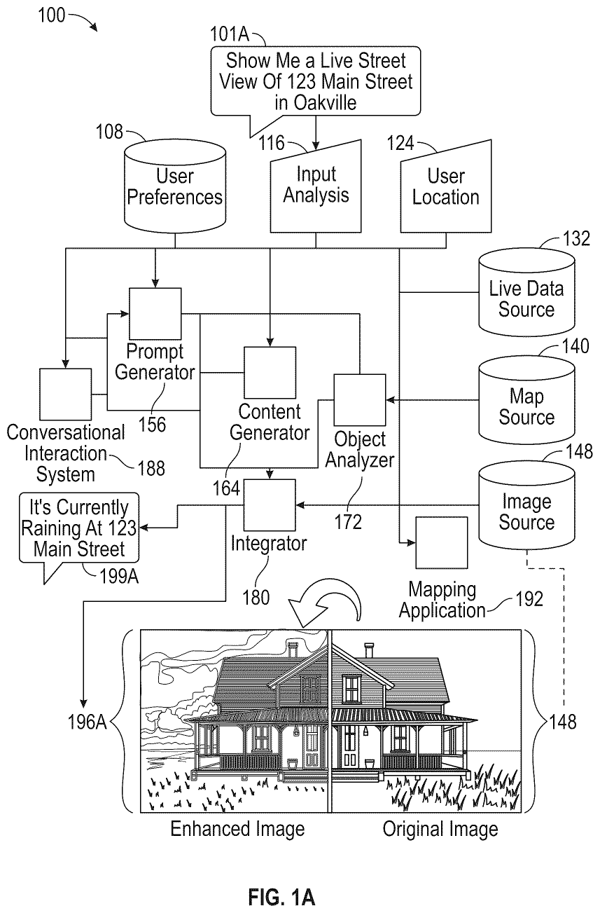

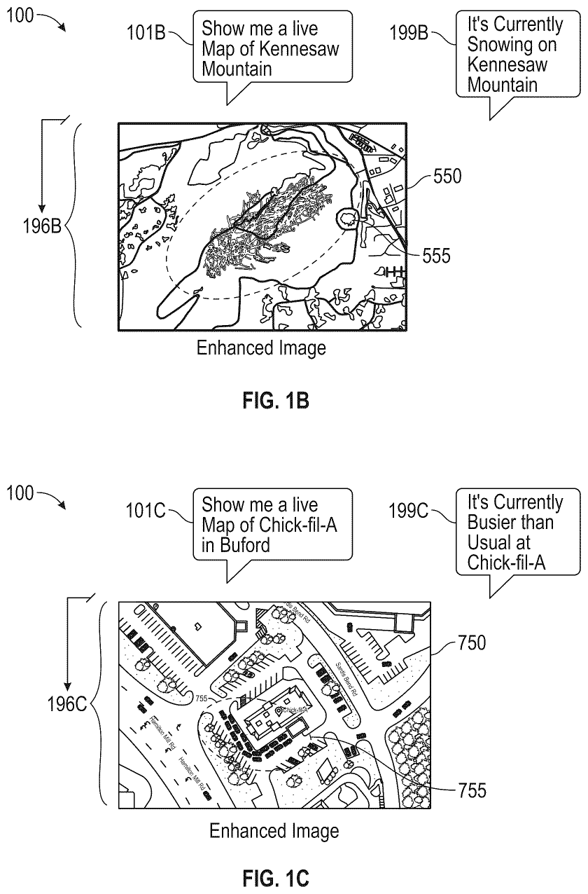

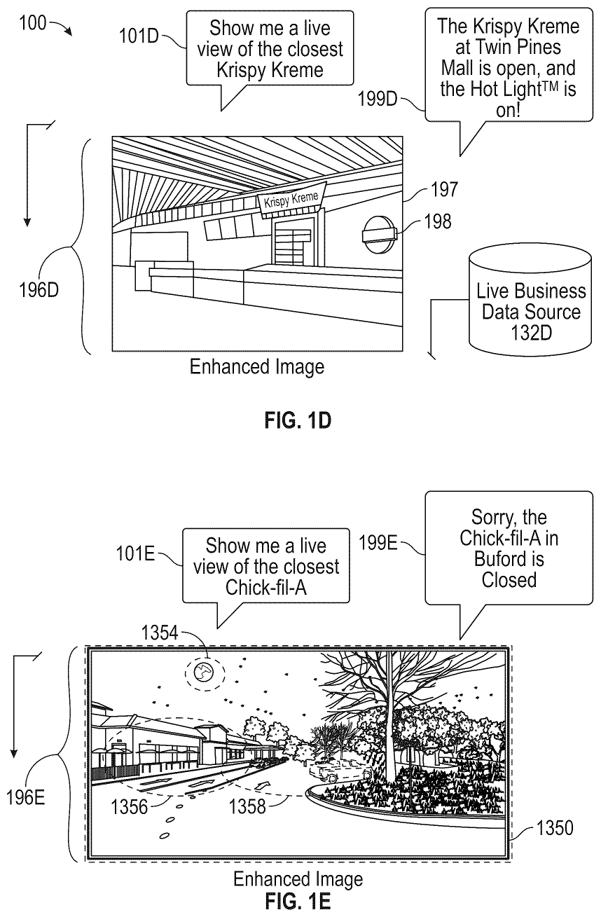

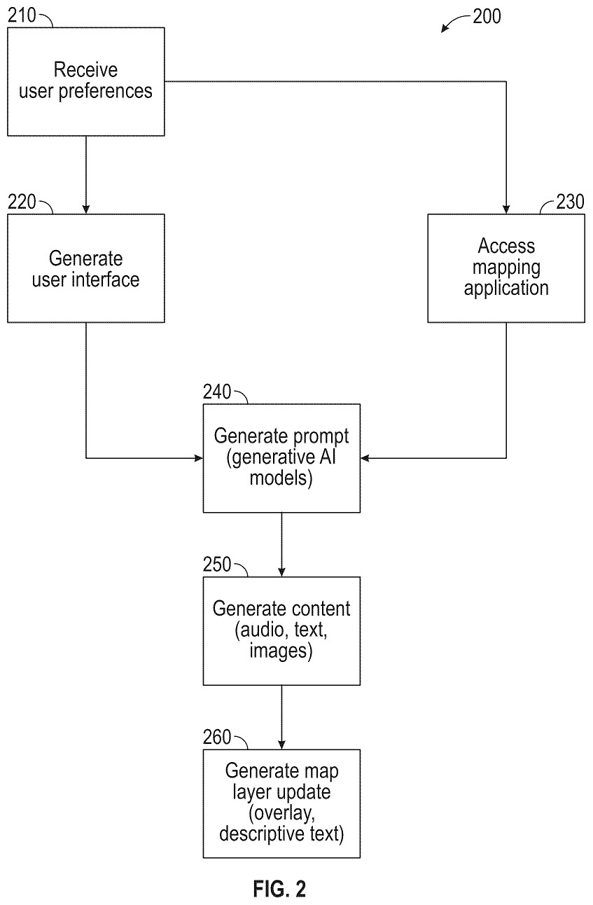

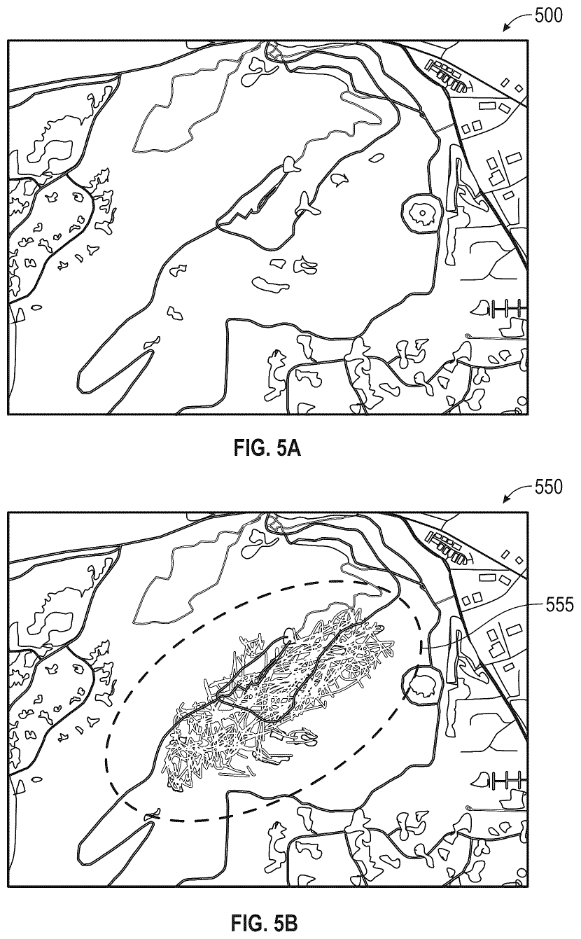

FIGS. 1A-1E depict examples of system architecture, inputs, and output. FIGS. 2-4, 9, 11, and 12 depict examples of related processes. FIGS. 5A, 5B, 6A, 6B, 7A-7E, 8A-8D, 10A, 10B, 13A, 13B, 14A-14G, and 15A-15D depict examples of related inputs, intermediate outputs, and final outputs.

FIG. 1A depicts a system 100 for utilizing generative AI to create prompts, integrate information, and apply resultant artifacts to generate enhanced audiovisual content, e.g., navigational audiovisual content, in accordance with some embodiments of the disclosure. It is noted that generative AI herein refers to a type of artificial intelligence that is configured to generate unique artifacts by analyzing data. The artifacts are used for a variety of purposes. Generative AI creates at least one of content, text, images, videos, audio, structures, computer code, synthetic data, workflows, physical object models, combinations of the same, or the like. The system 100 includes at least one of a user preferences module 108, an input analysis module 116, a user location module 124, a live data source 132, a map source 140, an image source 148, a prompt generator 156, a content generator 164, an object analyzer 172, an integrator 180, a conversational interaction system 188, a mapping application 192, combinations of the same, or the like. The system 100 is configured to generate an enhanced image 196A. Although these features are depicted and described as separate units of a single system, in some embodiments, one or more functions of one or more of these units are combined in a single unit, iterated, duplicated, separated, distributed across multiple systems, performed locally, performed remotely, performed in parallel, performed in series, and/or omitted, in any suitable combination. The description herein of a function performed by one unit does not preclude such functionality being performed, in addition or separately, by another unit. For example, one or more of the functions of the conversational interaction system 188 may be performed by the input analysis module 116, or vice versa. Although portions of the disclosure focus on examples related to maps and related views of mapping information, it is understood that the present methods and systems are applicable to other types of imagery, for instance, when it is desired to update an appearance of the original imagery over time. The arrows between units provided in FIG. 1A indicate non-limiting examples of a direction of flow of information through units of the system 100.

The user preferences module 108 is configured to determine user preferences based on at least one of detected events, past behavior, user input, combinations of the same, or the like. A user profile is generated that reflects the user's current preferences. Events associated with users are monitored, this data is processed to identify preference-altering events, and user profiles are updated accordingly. Activities inconsistent with user preferences are detected, events triggered by these activities are identified, and user preference criteria are derived from these events. User preferences of other users having, for example, the same demographics, familial connections, or social networks as a primary user are included in some embodiments. Events and preference changes are identified and cross-referenced with databases. The events and preference changes are compared with activity frequency and/or duration thresholds.

The input analysis module 116 is configured to receive a prompt or query, for example, prompt 101A of FIG. 1A (e.g., “Show me a live street view of 123 Main Street in Oakville”). The input analysis module 116 is configured to examine and interpret the prompt or query 101A to provide meaningful information for subsequent processing. The input analysis module 116 comprises various techniques such as data cleaning, transformation, and modeling to discover useful patterns or insights. The input analysis module 116 is configured to detect trends, patterns, and relationships within the data. For example, the system 100 is configured to parse the prompt or query 101A and identify a key term (e.g., “live”) that indicates a user intent to generate enhanced content including live information. The system 100 is configured to identify variations of the prompt or query 101A “Show me a live street view of 123 Main Street in Oakville.” In another example, when the prompt or query 101A is a phrase such as “I want to see what 123 Main Street in Oakville looks like now,” the phrase “looks like now” in context is an indicator of the user intent to generate enhanced content. Similarly, when the prompt or query 101A is “What does 123 Main Street in Oakville look like today?,” the phrase “look like today” in determined to be the indicator. In another example, when the prompt or query 101A is “Generate a current view of 123 Main Street in Oakville,” the phrase “current view” is determined to be the indicator. Any of the exemplary requests noted above is provided by a user in some embodiments. In other embodiments, such requests (or equivalents thereof) are automatically generated based on parameters sent to the AI system. For example, in an embodiment configured to generate directional mapping, a phrase such as “looks like today” is provided as part of the application programming interface (API) with associated information regarding the user currently driving in a given area. If the user desires, for example, a satellite view of an area (e.g., a satellite view from Google Maps), in some embodiments, regardless of whether a phrase such as “looks like today” is present, and the system 100 is configured to generate information for a current day and time and based on current conditions (e.g., current weather conditions) utilizing appropriately adjusted API parameters for the query.

The input analysis module 116 is configured to receive various types of input from an input device and/or input interface of a user device, such as a virtual keyboard of a smartphone and/or a microphone of a smartphone. For audio inputs, the audio input is converted to text using speech-to-text processing. In some embodiments, the input analysis module 116 is configured to parse and/or analyze the prompt or query 101A. The input analysis module 116 is configured to determine user intent from the search input. In some embodiments, the intent is inferred by the conversational interaction system 188 configured to perform related methods. The input analysis module 116 is configured to infer user intent in various contexts, such as conversation sessions and search inputs, particularly when ambiguity is present. Processors, linguistic elements, content access, and domain associations are configured to deliver relevant content to users. Also, the processors, linguistic elements, and metadata structures are configured to handle continuous user interactions, resolve ambiguity in search inputs, and maintain conversation sessions. Further, the processors, linguistic elements, and metadata structures comprise graph-based structures and domain associations to select relevant content items aligned with user preferences, ensuring contextually appropriate responses and enhancing the overall user experience. Details of the conversational interaction system 188 and related methods are provided in the “Conversational Interaction System” section herein (beginning at paragraph [0180]).

In some embodiments, the user location module 124 is configured to determine a location of a connected device using any suitable means, including at least one of a global positioning system (GPS), a cell phone system, an internet provider system, combinations of the same, or the like. With mapping applications, the user location from the user location module 124 is utilized to generate, for example, route guidance, directions, and the like.

The live data source 132 includes information obtained via internet or from any suitable data storage. The source of information may be an API configured to retrieve a particular type of information, particularly live event information. The source for the information includes at least one of geographic information system (GIS) information, geospatial information, traffic information, sports event information, reality show information, concert event information, gaming event information, weather event information, political event information, stock market event information, news event information, information about a family member of a participant mentioned in the prompt or query 101A, information about a pet of the participant mentioned in the prompt or query 101A, celebrity information (e.g., a politician, or a famous person such as Albert Einstein), famous place information (e.g., the Eiffel Tower), famous object information (e.g., the Hope Diamond), a consumer product (e.g., a home for sale), combinations of the same, or the like.

The map source 140 includes any suitable source of map imagery and related information including at least one of census data, images (e.g., aerial, satellite, drone, and the like), open data portals, photographs, remote sensing data, social media data, spatial data, survey data, topographic maps, combinations of the same, or the like.

The image source 148 includes any suitable source of imagery and related information including at least one of creative commons, digital libraries and archives, public domain images, professional photographers, social media platforms, stock photo websites, user-generated content, combinations of the same, or the like. The original image (right side of the bottom of FIG. 1A) is an example of an image from the image source 148.

The prompt generator 156 is configured to receive inputs from at least one of a prompt or query 101A, the user preferences module 108, the input analysis module 116, the user location module 124, the live data source 132, the map source 140, the image source 148, combinations of the same, or the like. The prompt generator 156 is configured to select one or more pieces of information from these inputs and convert the information into a format suitable for a generative AI system. Non-limiting examples of the prompt generator 156 are detailed herein.

For example, utilizing the input analysis module 116 and/or the conversational interaction system 188, in response to receipt of the prompt or query 101A of “Show me a live street view of 123 Main Street in Oakville,” “Show me” is determined to be a command to generate some form of visual output, “a live street view” specifies a type of output, and “123 Main Street in Oakville” is recognized as an address. The prompt generator 156 is configured to search the user preferences module 108 for similar prompts or queries to confirm successful examples of input and processing leading to output determined to be satisfactory to the user. The prompt generator 156 is configured to search the live data source 132 for live information regarding the address “123 Main Street in Oakville.” For example, the search of the live data source 132 may determine that it is currently raining at the address. The prompt generator 156 is configured to retrieve from the map source 140 an appropriate map for the address. The object analyzer 172 is configured to analyze an image from the map source 140 and/or the image source 148 for objects. The prompt generator 156 is configured to retrieve from the image source 148 images of the identified objects related to “rain” and examples of an appearance of solid objects subjected to rain. The prompt generator 156 is configured to compile this information into a prompt having a format suitable for the content generator 164.

Based on these inputs, the prompt generator 156 is configured to generate a detailed prompt. The detailed prompt includes one or more portions of the prompt or query 101A, detailed sub-prompts such as a weather context sub-prompt with instructions for searching for trusted weather information (e.g., from a weather API), an image source sub-prompt including instructions for specific types of sources (e.g., public tax records, commercial real estate websites, mapping applications, and the like) of desired image information, an image synthesis sub-prompt including image configuration parameters, a sub-prompt for weather-specific integration, a realism check, privacy considerations, source citing, combinations of the same, or the like. An example of the detailed prompt generated by the prompt generator 156 is as follows:
Generate a realistic, live view of 123 Main Street in Oakville under the current rainy weather condition.
1. * Weather Context: *
   Start by confirming the current weather in Oakville and establish that it is raining. Use reliable weather sources like local weather stations, forecasts from trusted weather websites, or real-time weather APIs.
2. * Image Sourcing: *
   Collect publicly available images of 123 Main Street in Oakville from various sources. These should include:
      a. Public tax records-Look for any publicly accessible government or municipal databases that have property images based on tax records.
      b. Zillow-Check if there are any listings or past listings for 123 Main Street in Oakville on Zillow, and retrieve the images associated with this address.
      c. Google Street View-Use Google Street View to obtain a current and clear image of 123 Main Street in Oakville.
3. * Image Synthesis: *
   Based on the images obtained from steps 2a, 2b, and 2c, create a composite and realistic view of 123 Main Street. The image should be clear and represent the property from an angle that resembles a “live view”.
4. * Rainy Weather Integration: *
   Modify the composite image created in step 3 to reflect the current rainy weather in Oakville. This should involve:
      a. Adding realistic rain effects-such as raindrops, wet surfaces, and appropriate lighting, each based on current weather conditions and a current date and time.
      b. Ensuring that the surroundings, like streets and trees, also appear as they would during a rainstorm (e.g., wet and reflective surfaces, darker sky, etc.)
5. * Realism Check: *
   Ensure that the final image looks realistic and does not have obvious signs of editing. It should genuinely appear as a live view of 123 Main Street in Oakville under current rainy conditions.
6. * Privacy Considerations: *
   Ensure that any identifiable information, such as people, license plates, or private property details that are not relevant to the address in question, are obscured or removed from the image.
7. * Source Citing: *
   Clearly indicate the sources from which the images were obtained and note that the final image is a digitally constructed view and not a live camera feed.

The content generator 164 is configured to receive a detailed prompt from the prompt generator 156. For example, a generative AI system such as MidJourney processes the detailed prompt and produces initial output. Non-limiting examples of the content generator 164 are detailed herein.

The object analyzer 172 and/or the integrator 180 are configured to analyze the output from the content generator 164 for one or more quality metrics. The object analyzer 172 and/or the integrator 180 are configured to access and compare the output to stored records in the user preferences module 108 to indicate a level of conformity with the one or more quality metrics. In some embodiments, the object analyzer 172 and/or the integrator 180 are configured to select from among a plurality of outputs from the content generator 164 for a best result having, for example, a highest score based on the one or more quality metrics. The enhanced image 196A (left side of the bottom of FIG. 1A) is an example of the best result from the integrator 180. In some embodiments, the plurality of outputs are generated for display to a device and prompting for user selection from among the plurality of outputs. The subsequent user selections are recorded by the user preferences module 108 to inform and improve future iterations of the process, in some embodiments.

In some embodiments, the system 100 is configured to output additional output related to the enhanced image 196A. For example, utilizing the conversational interaction system 188, the system 100 is configured to generate and output a related message 199A, such as “It's currently raining at 123 Main Street.”

Portions of different embodiments of the system 100 are shown in each FIGS. 1B-1E. It is to be understood that each embodiment of the system 100 shown in FIGS. 1B-1E includes one, more, or all of the features of the system 100 of FIG. 1A.

As shown in FIG. 1B, the system 100 is configured to receive a prompt or query 101B such as “Show me a live map of Kennesaw Mountain.” In response, the system 100 is configured to generate and transmit an enhanced image 196B. The enhanced image 196B includes an enhanced map image 550 including a depiction 555 of a live weather condition. The system 100 is also configured to generate and transmit a related message 199B, such as “It's currently snowing on Kennesaw Mountain.” Additional details are provided in the description of FIGS. 5A and 5B below.

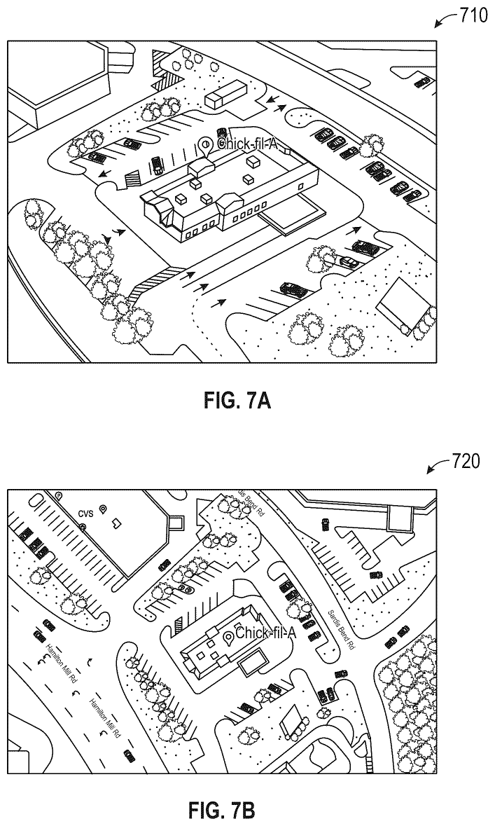

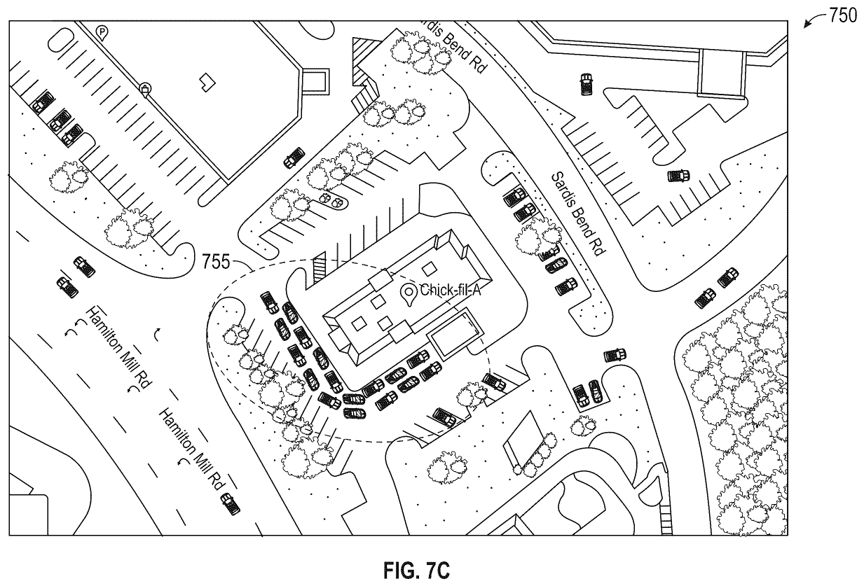

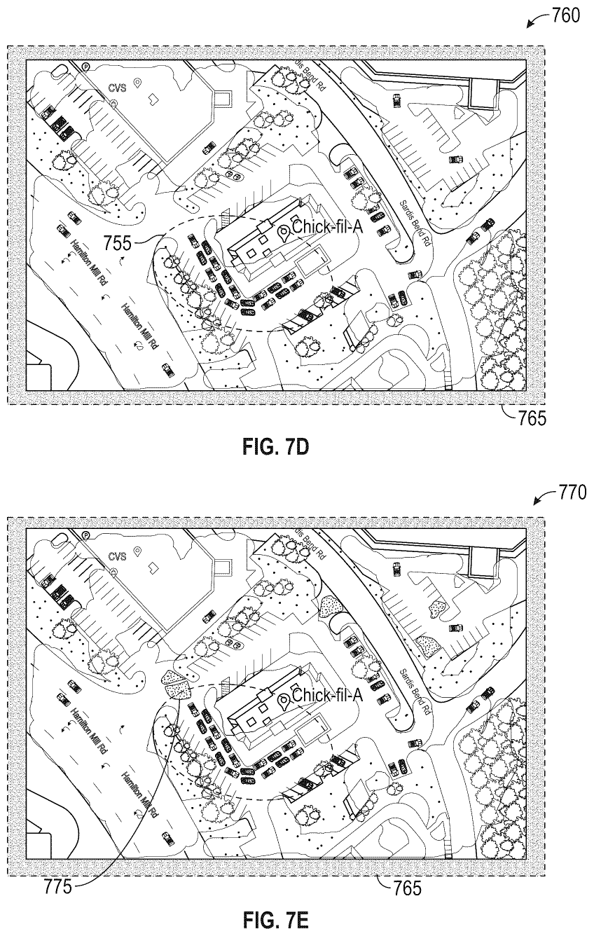

As shown in FIG. 1C, the system 100 is configured to receive a prompt or query 101C such as “Show me a live map of Chick-fil-a in Buford.” In response, the system 100 is configured to generate and transmit an enhanced image 196C. The enhanced image 196C includes an enhanced map image 750 including a depiction 755 of a live traffic condition. The system 100 is also configured to generate and transmit a related message 199C, such as “It's currently busier than usual at Chick-fil-a.” Additional details are provided in the description of FIGS. 7A-7E below.

As shown in FIG. 1D, the system 100 is configured to receive a prompt or query 101D such as “Show me a live view of the closest Krispy Kreme.” In response, the system 100 is configured to generate and transmit an enhanced image 196D. The enhanced image 196D includes an enhanced business image 197 including a depiction 198 of a live business-specific condition. The system 100 is configured to access a live business data source 132D. In this example, the live business data source 132D is controlled by an owner of the Krispy Kreme franchise at Twin Pines Mall, and an API provides information regarding a status of a live business-specific feature, e.g., the Krispy Kreme Hot Light™. When the system indicates the Hot Light™ is in an “on” and operative state, the depiction 198 of the live business-specific condition includes a version of the Hot Light in its operative state. The system 100 is also configured to generate and transmit a related message 199D, such as “The Krispy Kreme at Twin Pines Mall is open, and the Hot Light™ is on!” In some embodiments, live business data source 132D includes at least one of a physical sensor located at the business, a camera focused on a physical sign located at a business, a signal from a point-of-sale system, combinations of the same, or the like. The sensor is monitored to detect changes in a condition of an object of the sensor, and the imagery produced by the system 100 thus includes live information generated by the sensor.

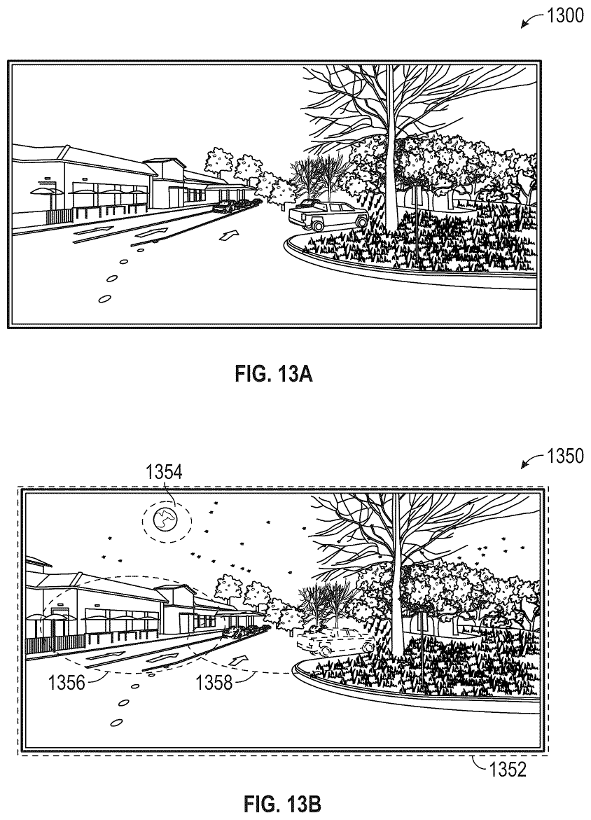

As shown in FIG. 1E, the system 100 is configured to receive a prompt or query 101E such as “Show me a live view of the closest Chick-fil-a.” In response, the system 100 is configured to generate and transmit an enhanced image 196E. The enhanced image 196E includes an enhanced street view image 1350 including depictions 1353, 1356, 1359 of live weather information, live business-related building information, and live traffic-related information for the location, respectively. The system 100 is also configured to generate and transmit a related message 199E, such as “Sorry, the Chick-fil-a in Buford is closed.” Additional details are provided in the description of FIGS. 13A and 13B below.

In some embodiments, the system 100 includes a generative AI tasked with a specific toolset and inputs without use of NLP. In some embodiments, the system 100 includes a mapping application 192 (FIG. 1A). The system 100 is configured to generate a prompt that includes an NLP prompt such as, for example, the following:
Show the chick-fil-a located at 355 Buford Highway, Georgia, USA with a line of cars waiting to pass thru the drive-thru during a rainstorm, make sure to show details of how the rainfall affects the look of the roads.

In some embodiments, a prompt is generated with a generative AI tool configured with a toolset (e.g., a pre-trained toolset) specifically for enhanced mapping imagery in accordance with the present disclosure and without use of NLP.

The system 100 is configured to generate a prompt such as this and transmit the prompt to a generative AI system such as ChatGPT, which acts as an agent for other AI systems. In some embodiments, the system 100 incorporates various AI systems within its own mapping application 192 and skips one or more steps to generate inputs to various tools, such as, for example, using the following steps:
Step 1: tool: customMapFetch1, query: fetch all data associated with POI ID: 2436576

That is, Step 1 includes a call for a tool, customMapFetch1, and a query to the tool requesting all data associated with a POI having a unique identifier. Step 1 returns, for example, the following:

{
POI ID:2436576, name:Chick-Fil-A 243, Address: {355 Buford
Highway, Buford, GA, 31586, USA}, Store Hours: {m-s,6-10},
menu_url:“http://www.chick-fil-a.com/menu?store_id=243”
}

That is, Step 1 repeats portions of the input query (e.g., the POI unique identifier), and provides a name, address, store hours, and menu URL for the POI. The result from Step 1 is used for Steps 2-4, for example:
Step 2: tool: websearch, query: fetch_url: http://www.chick-fil-a.com/menu?store id=243
Step 3: tool: webpage parser, query: parse output
Step 4: tool: weatherSearch, query: todays date time, location: 355 Buford Highway, Buford, GA, 31586, USA
Step 5: tool: customMapObjectRetrieval, query: fetch image from map for POI ID: 2436576, altitude: 1000, tilt: 45, orientation: SE

That is, the specified website is queried, the output is parsed, weather information is obtained, an image related to the POI is retrieved, and specific information regarding an altitude, tilt, and orientation of the desired image is provided. Such a query returns an image 700 such as that shown in FIG. 7A.

The image 700 is then sent to a generative AI imaging system for processing:
Step 6: tool: generativeImaging, query: image from previous step, adding weather data from previous step, showing long lines at drive-thru from previous step
Step 7: tool: map_layer_tool, query: update overlay raster layer on user map for POI: 2436576, altitude: 1000, tilt: 45, orientation: SE, image: from previous step

In this way, the mapping application 192 iteratively generates additional overlays, enhanced content, and other information, which is added to various map layers.

In mapping applications, layers are used to display and organize different types of geographic information and data on a map. Each layer represents a specific type of data or feature, such as roads, buildings, terrain, land use, POI, combinations of the same, or the like. By using layers, a mapping application presents complex and varied information in a structured and visually understandable manner. For example, base layers provide fundamental geographic context for the map, typically consisting of street maps, satellite imagery, terrain data, combinations of the same, or the like. Other types of layers such as vector layers represent geographic features as points, lines, and polygons, such as roads, rivers, administrative boundaries, POI, combinations of the same, or the like. Raster layers are utilized in some embodiments. Raster layers display continuous data or images, such as aerial photographs, satellite images, digital elevation models (DEMs), combinations of the same, or the like.

In some embodiments, weather information is utilized. The weather information informs an AI prompt system, such as the prompt generator 156, to compose prompts for generative AI systems to consider weather conditions when generating audio, images, descriptive texts, and the like. By considering weather data, map objects are generated to give a realistic view of the map object in differing conditions. In some embodiments, this technique is applied to 3D objects. For example, for mapping systems such as Google Maps with 3D buildings, the base building image (a 3D model) is adjusted by a generative AI system in accordance with a prompt, for example, from the prompt generator 156. For example, a generative AI, such as the content generator 164, is configured to generate the enhanced image 196A based on the original image 148, as depicted at the bottom of FIG. 1A. In order to generate the enhanced image 196A, a prompt from the prompt generator 156 includes a description of a wet, rainy day with many rain clouds. Other weather conditions, such as a dry, sunny day, are prompted and generated as appropriate. In this example, a street view tilt and/or angle are specified; however, any angle may be added to the prompt for an aerial view, a 2D top view, and other views of a mapping application 192. In some embodiments, instructions to output ambient sound are added to the output.

Enhancements to mapping application interactions are provided. With mapping applications (such as Apple Maps or Google Maps), users engage with the map in various ways, including directly touching a location, using gestures to zoom in or out, and searching for specific entities or locations. In addition, a method and a system are provided to generate prompts based on data linked to the selected location on the map. A base map (e.g., a satellite imagery map) is enhanced by incorporating additional content, such as auditory information and/or visual elements. The additional content is integrated into a raster overlay layer in some embodiments.

In response to selecting a location through a location selection method, the mapping application 192 identifies the map point or central point of the location. Additionally, the viewport of the display device, which can encompass either a partial or complete area of the map, along with the zoom level, and 3D tilt mode and/or viewing angle, if applicable, are considered. Considering the user preferences and the selected location, the method and system are configured to generate one or more prompts, themselves configured for input into one or more generative AI systems that utilize a wide array of data points related to the map to produce desirable output. POIs include various features such as commercial establishments (e.g., shopping centers, retail stores, and the like), dining venues (e.g., restaurants, cafes, and the like), transportation options (e.g., trains, buses, ferries, and the like), and natural landmarks (e.g., lakes, rivers, beaches, and the like). Furthermore, topographical elements like basins, mountain ranges, deserts, and other landforms are consistently incorporated into layers of the mapping application 192, resulting in comprehensive geographic information.

As a map is loaded into the viewport of the display device, data extracted from these POI layers is conveyed to the prompt generator 156. In some embodiments, the prompt generator 156 is an AI-based language model and/or NLP platform configured to generate contextually relevant prompts. In some embodiments, the extracted data may include at least one of contextual information, such as store hours for commercial establishments, place names, website information (URLs), reviews, other informative data, combinations of the same, or the like. This data is combined with other information to be used by the prompt generator 156. Additionally, external data, including at least one of traffic data, drive-through wait times, weather data, traffic accident data, construction data, personal data (e.g., the make and model of a user's vehicle), combinations of the same, or the like are utilized by the prompt generator 156.

In some embodiments, in response to receiving the generated prompts from the prompt generator 156, the content generator 164 is configured to create objects suitable for integration into specific map layers. These objects are then added to the map using current techniques in the field. For example, the integrator 180 is configured to add objects to the map.

FIG. 2 depicts a process 200 for generating a user interface, a prompt, content, and a map layer update. The process 200 includes receiving 210 user preferences, e.g., from the user preferences module 108. The process 200 includes generating 220 a user interface based on the received user preferences. The process 200 includes, in parallel in some embodiments, accessing 230 a mapping application 192. The process 200 includes receiving selections from the user interface (between 220 and 240). The process 200 includes receiving information from the mapping application 192 (between 230 and 240). The process 200 includes generating 240 a prompt with the prompt generator 156, which is configured for one or more generative AI models. The process 200 includes generating 250 content with the content generator 164 to produce output such as audio, text, images, and/or video. The process 200 includes generating 260 a map layer update with the content generator 164 to produce, e.g., an overlay and/or descriptive text.

In one embodiment, the prompt generator 156 is configured to utilize map location data to generate prompts for the content generator 164 to create ambient sounds for a given location and zoom level. For example, if a user is zoomed relatively far out, the system 100 is instructed not to generate ambient sounds. However, at varying zoom levels, which are relatively closer to a lowest possible zoom level, the system 100 is configured to generate ambient sounds. An example of a data set used to generate ambient sounds for a particular map region and zoom level is as follows:
{region: state of Georgia, zoom level: 3}

With this zoom level instruction, a zoom level of 3 is correlated with a prose description, such as “in the region of middle Georgia,” and the prompt generator 156 generates a prompt for a generative audio AI system, such as the following:
Create ambient sounds for a location in the region of middle Georgia capturing the atmosphere, natural surroundings, and cultural essence of the area in an immersive and engaging audio experience.

In some embodiments, the generated prompt utilizes relatively less natural, more functional language configured for suitability for a back-end generative AI system.

The system 100 is configured to receive a user selection changing the zoom level, which is converted to code, such as the following:
{region: City of Buford, zoom level: 10}

In response, the prompt generator 156 changes the prompt accordingly. For example, a zoom level of 10 is correlated with a prose description, such as “for the city of Buford” (as well as related verbiage dependent on zoom level), and the prompt generator 156 generates a new prompt for a fully zoomed-in location, such as the following:
Generate ambient sounds for the city of Buford, capturing the local atmosphere, urban environment, and distinct cultural vibes to create an immersive and engaging audio experience representative of this location.

Additionally, the content generator 164 is configured to convert the descriptive text based on the map location, a particular POI, and zoom level, for entry into NLP and/or LLM AI systems to create descriptive text and, by way of text-to-speech conversion, audio for a given location and zoom level. For example, if a user is zoomed relatively far out, the system 100 is configured to produce a relatively general description. However, at varying zoom levels, which are relatively closer to the lowest possible zoom level, the system 100 is configured to produce descriptions that are highly detailed. An example of a data set used to generate descriptive text for a particular map region and zoom level is as follows:
{region: state of Georgia, zoom level: 3}

With this data set, the prompt generator 156 is configured to produce an LLM prompt such as the following:
Compose a descriptive text for locations within the region of Georgia, highlighting the unique geographical features, cultural aspects, notable landmarks, and points of interest, providing an informative and engaging overview of the area on the map.

The system 100 is configured to receive a user selection changing the zoom level, which is converted to intermediate code, such as the following:
{region: City of Buford, zoom level: 10}

In response to the user selection, the prompt generator 156 is configured to produce an LLM prompt such as the following:
Compose a descriptive text for locations within the City of Buford, Georgia, emphasizing its distinctive landmarks, local history, cultural attractions, and points of interest, offering a captivating and insightful portrayal of the area.

The system 100 is configured to determine, for example, a wait time and weather at a business by accessing and querying the live data source 132. Such query results, for example, in intermediate code, such as the following:
{POI: chick-fil-a restaurant ({wait time: longer than normal}), zoom level: 10, weather: rainy}

The system 100 is configured to input the above intermediate code into the prompt generator 156 (e.g., an LLM AI system), which generates a prompt such as the following:
Compose a detailed description of a Chick-fil-a restaurant during its breakfast service, highlighting the long wait time, the fact that it is currently open, and the rainy weather outside, capturing the ambiance, customer experience, and unique challenges presented by the circumstances.

The system 100 is configured to input the above prompt into the content generator 164 (e.g., an LLM AI system), which generates descriptive text such as the following:
Nestled amidst the early morning drizzle, the Chick-fil-a at 355 Buford Highway welcomes hungry patrons seeking a warm, delicious breakfast. Despite the steady downpour outside, we are open and eager to serve our wonderful customers. As the raindrops tap rhythmically against the windows, the line of cars at the drive-thru stretches around the building, showcasing an impressive display of patience and dedication for everyone this morning. The gloomy weather, however, cannot dampen the enthusiasm of our excellent staff, who, with unwavering smiles and efficiency, are working tirelessly to accommodate the high demand. Inside, the aroma of freshly prepared biscuits, sizzling bacon, and savory chicken wafts through the air, inviting you to enjoy our freshly made breakfast meals.
Inside, you will experience a blend of cozy warmth and determination persevering through the extended wait time for their cherished breakfast treats. The rainy weather presents unique challenges, with the staff taking extra care to package the orders securely, ensuring that the food stays warm and dry during the handoff.
In the face of the long wait time and rainy conditions, the Chick-fil-a at 355 Buford Highway continues to provide an exceptional customer experience. The unwavering commitment to quality food, efficient service, and a welcoming atmosphere shines through, proving that neither rain nor long lines can dampen the spirit of this cherished breakfast destination.

In some embodiments, the integrator 180 is configured to assess a likelihood the text will be satisfactory to the user before transmitting the text to the user. For example, the user preferences module 108 stores an indicator that the user prefers relatively short audio annotations (e.g., configuring the prompt so that the output has less than about 100 words and/or a duration of the spoken text is about 15-30 seconds, or the like). In response, the integrator 180 is configured to convert the relatively longer text above, in accordance with preferences from the user preferences module 108, into a shorter version of the text, for example, as follows:
Welcome to Chick-fil-a at 355 Buford Highway, your go-to place for a warm, delicious breakfast. Rain or shine, our dedicated team is ready to serve you with a smile. The aroma of fresh biscuits, bacon, and chicken promises a delightful start to your day. Despite the weather, we ensure your food stays warm and dry. Join us for an exceptional breakfast experience.

The content generator 164 is configured to convert such text using text-to-speech conversion to read the text aloud to the user and/or display the text to the user's device.

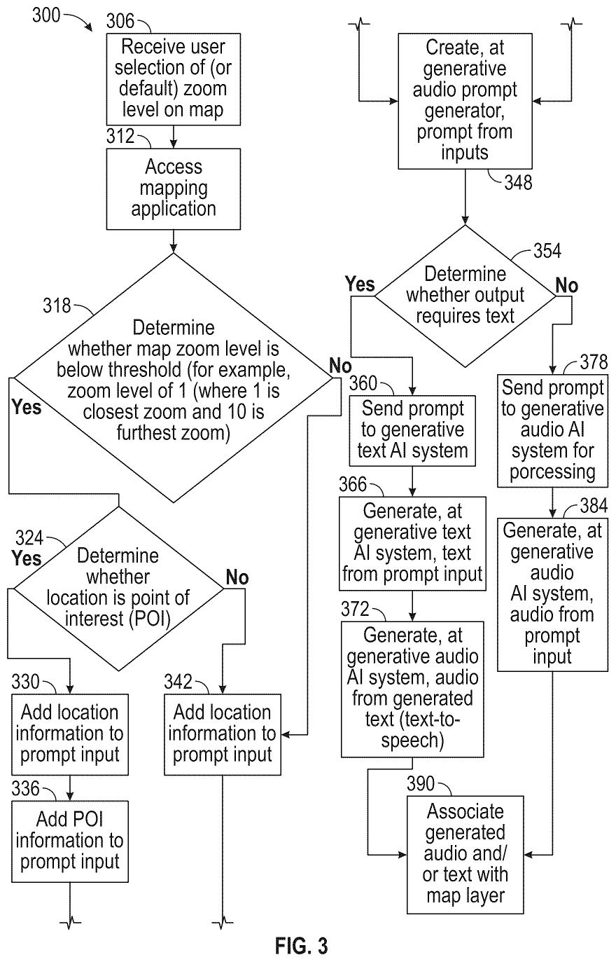

As shown in FIG. 3, a process 300 for generating AI prompts is provided. In some embodiments, the process 300 generates prompts that are used as input for the content generator (e.g., a generative audio AI system or the like) for creating output (e.g., ambient sounds or the like) associated with a location or POI on a map. The process 300 includes examples of data utilized by the prompt generator 156 to create various AI prompts for subsequent processing.

The process 300 includes receiving 306 a user selection of or a default setting for a zoom level on a map. In response to the receiving 306, the process 300 includes accessing 312 a mapping application 192. In response to the accessing 312, the process 300 includes determining 318 whether the map zoom level is below a threshold. For example, the threshold is 3, where a zoom level is between 1 and 10, where 1 is a closest zoom level, and 10 is a further zoom level. In some embodiments, other suitable thresholds and iterations of zoom levels are utilized. In response to determining 318 the map zoom level is below the threshold (318=“Yes”), the process 300 includes determining 324 whether a location is a POI. In response to determining 324 the location is the POI (324=“Yes”), the process 300 includes adding 330 location information to prompt input. Either in response to determining 318 the map zoom level is equal to or above the threshold (318=“No”) or in response to determining 324 the location is not the POI (324=“No”), the process 300 includes adding 342 location information to the prompt input. In response to adding 330 the location information to the prompt input, the process 300 includes adding 336 POI information to the prompt input. In some embodiments, location information and/or POI information is added to the prompt input prior to the determining 318, and the subsequent steps of the process 300 proceed directly to the creating 348 step (described below). In other words, steps 324, 330, 336, and 342 are performed between steps 312 and 318 in some embodiments. Either in response to adding 336 the POI information to the prompt input or adding 342 the location information to the prompt input, the process 300 includes creating 348, at the prompt generator 156 (e.g., a generative audio prompt generator), a prompt from the received inputs. In response to the creating 348 of the prompt, the process 300 includes determining 354 whether output requires text. In response to determining 354 the output requires the text (354=“Yes”), the process 300 includes sending 360 the prompt to the content generator 164 (e.g., a generative text AI system). In some embodiments, where no audio is desired, requested or available, step 348 is skipped or omitted. In response to sending 360 the prompt, the process 300 includes generating 366, at the content generator 164 (e.g., the generative text AI system), text from the prompt input. In response to the generating 366 of the text, the process 300 includes generating 372, at the content generator 164 (e.g., a generative audio AI system), audio from the generated text (e.g., using text-to-speech conversion). In response to determining 354 the output does not require text (354=“No”), the process 300 includes sending 378 the prompt to the content generator 164 (e.g., the generative audio AI system) for processing. In response to the sending 378 of the prompt, the process 300 includes generating 384, at the content generator 164 (e.g., the generative audio AI system), audio from the prompt input. Either in response to the generating 372 the audio or the sending 384 the audio, the process 300 includes associating 390 the generated audio and/or the generated text with a map layer.

In some embodiments, external data is sent to the prompt generator 156 to generate at least one object suitable for overlay onto a map within a mapping application 192. The external data includes at least one of traffic data, weather data, POI-specific data (e.g., drive-through wait times), combinations of the same, or the like. The external data is combined with existing map data (e.g., topographical data). The generated object includes at least one of an image suitable for addition to a raster image layer, a 3D object (which is added to a 3D layer in some embodiments), one or more views of the object, combinations of the same, or the like. Such generated objects increase the efficiency and speed of the system 100 in some embodiments. For example, when the system 100 determines that weather data indicates snowfall, and topographical data indicates a mountain area, the system 100 is configured to generate an overlay that includes a satellite image (or other suitable imagery) that is modified by the system 100 to simulate an appearance of snow covering the mountain. Because it is not guaranteed that a satellite will pass over a particular region of the earth at a given time, there are use scenarios where no imagery of a given mountaintop covered with snow exists from available resources. Also, such functionality is useful for imaging novel, rare, and/or anomalous events like a hurricane force storm impacting an area (e.g., Newfoundland and Labrador) not normally (if ever) impacted by hurricanes. As such, for example, the system 100 is configured to generate an image of snow in real time and add the image to a raster layer, thus resulting in displayed output that visually conveys to the viewer that snow has fallen on the imaged area.

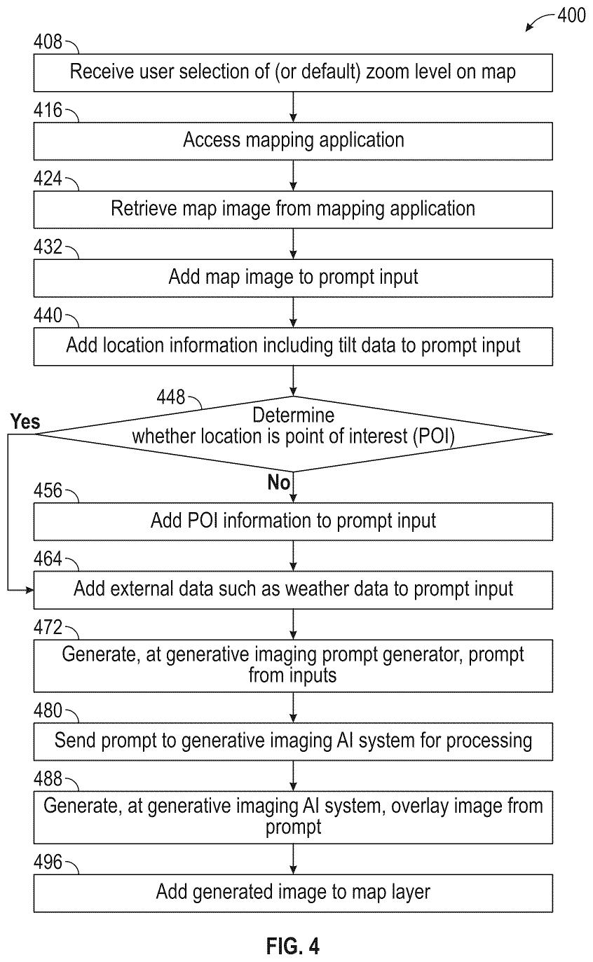

As shown in FIG. 4, a process 400 is provided for creating prompts for generative AI systems based on data provided by a mapping application 192 or from external data provided by the generative AI system (such as via a summarization of a web search as is known in the art). The process 400 includes using the prompts to create map layer overlays that augment existing map layers. The overlaps take into consideration factors including at least one of the map location, zoom level, tilt, external data, combinations of the same, or the like. The process 400 includes receiving 408 a user selection of or a default setting for a zoom level on a map. In response to the receiving 408, the process 400 includes accessing 416 a mapping application 192. In response to the accessing 416, the process 400 includes retrieving 424 a map image from the mapping application 192. In response to the retrieving 424, the process 400 includes adding 432 the map image to a prompt input. In response to the adding 432, the process 400 includes adding 440 location information including tilt data to the prompt input. In response to the adding 440, the process 400 includes determining 448 whether the location is a POI. In response to determining 448 the location is the POI (448=“Yes”), the process 400 includes adding 456 POI information to the prompt input. Either in response to adding 456 the POI information or in response to determining 448 the location is not the POI (448=“No”), the process 400 includes adding 464 external data (e.g., weather data) to the prompt input. In response to the adding 464 of the external data, the process 400 includes generating 472, at the prompt generator 156 (e.g., a generative imaging prompt generator), a prompt based on the inputs. In response to generating 472 the prompt, the process 400 includes sending 480 the prompt to the content generator 164 (e.g., a generative imaging AI system) for processing. In response to sending 480 the prompt, the process 400 includes generating 488, at the content generator 164 (e.g., the generative imaging AI system or another generative imaging AI system), an overlay image based on the prompt. In response to generating 488 the overlay image, the process 400 includes adding 496 the generated image to a map layer.

FIG. 5A depicts an example of a map image 500 showing a mountaintop as it would currently be seen in a mapping application 192 (e.g., Google Maps). FIG. 5B depicts an enhanced image 500 including an overlay 555 generated by the system 100 based on weather data indicating a light snowfall. In this example, the light snowfall occurred only at higher elevations. The system 100 is configured to render the depiction 555 in a manner that simulates the effect of the live weather condition (e.g., snow) on the environment depicted in the image 500. For example, shadows on surrounding objects in the image 500 are converted to shadows on snow in the depiction 555.

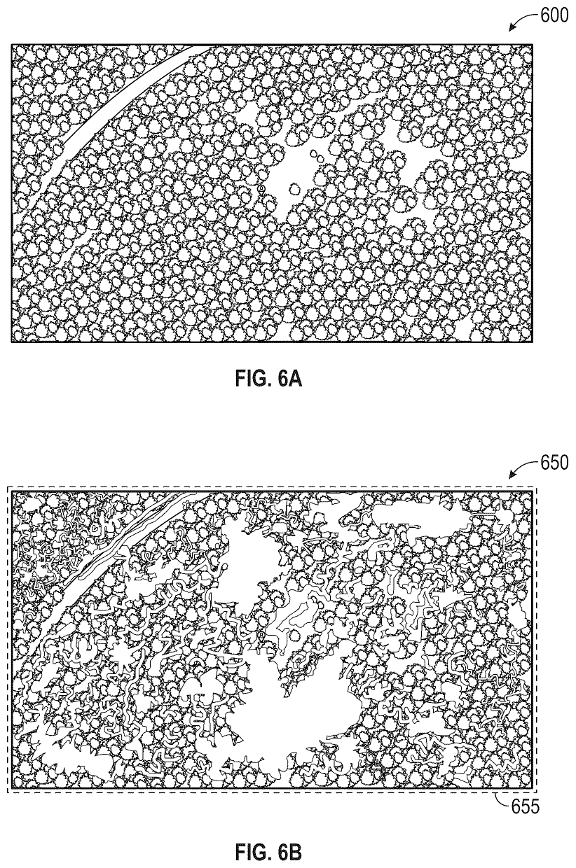

FIG. 6A depicts an example of a map image 600 showing a mountaintop as it would currently be seen in a mapping application 192 with a higher zoom level. FIG. 6B depicts an enhanced image 650 and an overlay 655 generated by the system 100 based on weather data indicating a light snowfall. In this example, at this relatively higher zoom level, the snow covers the entire viewport of the image 650.

FIG. 7A depicts a 3D map image 710 resulting from querying a specified website (described herein) regarding a drive-through restaurant as it would currently be seen in a mapping application 192. The image 710 is related to the POI at an altitude, tilt, and orientation in accordance with prompting from the system 100.

FIG. 7B depicts an example of a 2D map image 720 showing the drive-through restaurant as it would currently be seen in the mapping application 192.

FIG. 7C depicts an enhanced map 750 based on the image 710 and/or the image 720 with an overlay 755 generated by the system 100 based on POI data provided by the restaurant indicating long wait times at the drive-through. Additional objects are added to a raster layer generated based on a prompt with appropriate instructions for indicating the long line. In some embodiments, the object analyzer 172 analyzes the map image 710 and/or the map image 720 to determine one or more lanes of the drive-through. Objects representing different vehicles are generated by the content generator 164 based on a determined live busyness of the restaurant based on the live data source 132. Generated objects are added to the image 750 at a suitable scale. The colors for the objects representing the vehicles are selected at random in some embodiments or derived from a data source containing information relevant to the situation being depicted. For instance, the system 100 is configured to generate an image of a drive-through of a restaurant to include a variety of vehicles typical and suitable for such business (e.g., cars, SUVs, station wagons, and the like); whereas, the system 100 is configured to depict a long line at a truck-stop gas station with objects representing vehicles suitable for such (e.g., cargo trucks, tractor-trailers, and the like).

FIG. 7D depicts an enhanced map 760 based on the image 710 and/or the image 720 and/or the map 750 with an overlay 765 generated by the system 100 based on live weather information (e.g., indicating rain and rain clouds) from the live data source 132.

FIG. 7E depicts an enhanced map 770 based on the image 710 and/or the image 720 and/or the map 750 and/or the map 760 with an overlay 775 generated by the system 100. Objects in the imagery such as buildings, roads (including, e.g., asphalt surfaces versus concrete surfaces), rooftops, grassy areas, foliage, vehicles, pedestrians, shadows, reflections, and the like are identified. An effect of rain on each of the identified objects is rendered in the overlay 775.

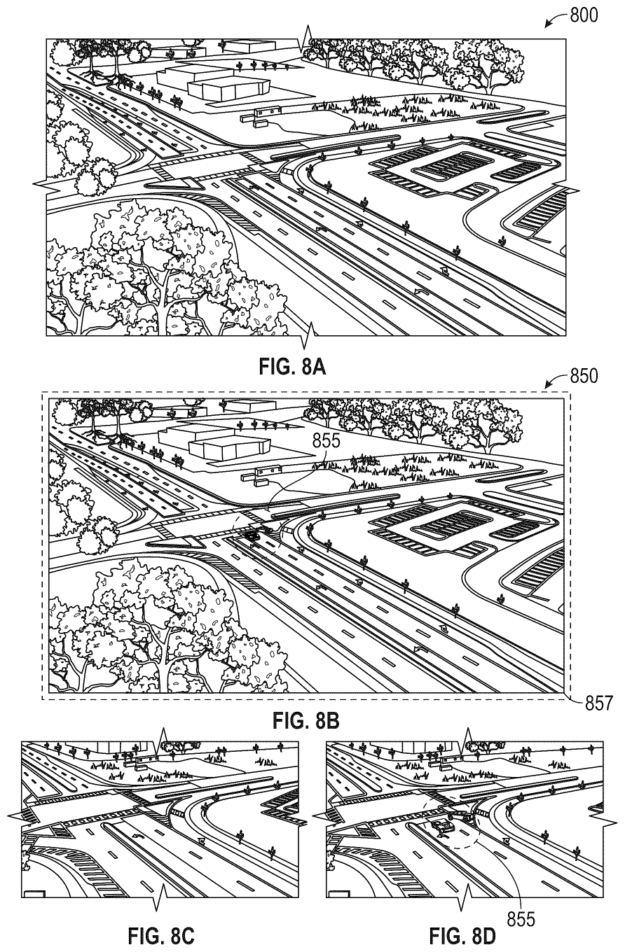

FIG. 8A depicts an example of a map 800 in a 3D view at a specified tilt. FIG. 8B depicts an enhanced map 850 based on the map 800 with an image overlay 855 of a pair of vehicles generated by prompting the content generator 164 (e.g., a generative AI system) including appropriate parameters. The appropriate parameters include, for this example, at least one of a make of each vehicle, a model of the vehicle (associated, e.g., with the user profile and/or user preferences of the user preferences module 108), a zoom level, weather data, and a 3D tilt angle. Additionally, the system 100 is configured to add data from a user device for rendering. For example, in some embodiments, a mapping application 192 running on a car infotainment system adds at least one of a speed of the vehicle, a status of a convertible roof of the vehicle, a status of a sunroof of the vehicle, data derived from sensors such as detected fog or other weather conditions, a detected make of the vehicle, a detected model of the vehicle, a color of one or more vehicles near or close to the subject vehicle, information from cameras resident on the subject vehicle, combinations of the same, or the like. The overlay 855 is placed on the map 850 at a GPS location associated with the user's actual, current location within the 3D mapping application 192. The map 850 also includes an overlay 857 depicting live weather conditions. In this example, an API call to a weather database indicates light snow at the current location of the vehicle, and the overlay 857 simulates the impact of the light snow on objects detected in the original and/or intermediate imagery.

In this example, the prompt generator 156 generates a prompt for the content generator 164 (e.g., a generative AI) such as the following:
Generate a 3D-rendered image of a red Ferrari Spider convertible with the top down, from a viewing angle of 30 degrees and an elevation of 10,000 feet, with the car facing west, capturing the vehicle's design, contours, and features in a visually compelling and accurate manner. Show a white Chevy Silverado pickup in the lane next to the car with snow on the road ahead.

The inclusion of the descriptions of the “red Ferrari Spider” and/or the “white Chevy Silverado pickup” in the prompt are, in some embodiments, based on at least one of user preference information (e.g., the year, make, and model of the user's own vehicle), a database of vehicles common to a given area at a given place and time, combinations of the same, or the like. FIG. 8C is a zoomed-in version 860 of the map 800. FIG. 8D is a zoomed-in version 870 of the map 850.

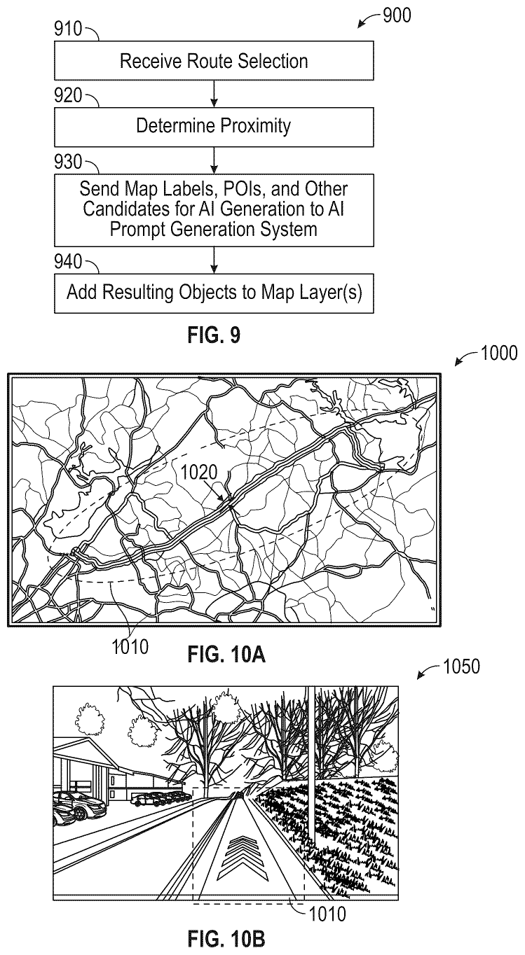

In some embodiments, AI prompts are pre-generated and processed for locations, POIs and other data points within a proximity of or along a map route (such as a driving or walking route). FIG. 9 depicts a process 900 for determining a proximity from a route selection, sending map labels, POIs, and other candidates for AI generation to an AI prompt generation system, and adding resulting objects to one or more map layers. The process 900 includes receiving 910 a route selection. In response to the receiving 910 of the route selection, the process 900 includes determining 920 a proximity to the selected route. In response to the determining 920 of the proximity, the process 900 includes sending 930 map labels, POIs, and other candidates for AI generation to the prompt generator 156 (e.g., an AI prompt generation system) based on the determined proximity and information regarding POIs along the route. In response to the sending 930, the process 900 includes adding 940 resulting objects to one or more map layers.

FIG. 10A depicts a map 1000 with an area 1010 (surrounded with a dashed line ellipse) along the route within a proximity 1020. The proximity 1020 is used to select one or more data points (e.g., map labels, POIs, and other items). The data points are sent to the prompt generator 156 (e.g., an AI prompt generation system) for generative AI object creation. In various embodiments, the proximity 1020 (e.g., about 1000 feet from the route) is determined by the system 100 based on information such as user preferences from the user preferences module 108, inputted by the user, determined based on usage patterns of similar users, set by an external entity, or the like. In some embodiments, the proximity 1020 is expanded near a start point, near an end point, and/or at major intersections, and the proximity 1020 is contracted along long, relatively desolate portions of the route. In some embodiments, the system 100 is configured to predict portions of the route having POIs likely to be of current and/or future interest to the user.

In some embodiments, the system 100 is configured to generate an enhanced street view for turn-by-turn navigation. For example, FIG. 10B depicts an enhanced street view 1050 including an overlay 1010 representing a path according to the turn-by-turn navigation. The view 1050 is based on and/or related to the map 1000 in some embodiments. A sequence of street view images is updated and streamed as video. For example, the content generator 164 (e.g., a generative AI) is configured to generate the sequence of images based on at least one of a time of day, a direction of travel, current speed, current weather, current traffic, insertion and removal of objects representing vehicles based on the current traffic, combinations of the same, or the like. Satellite images are leveraged to provide the most up-to-date street view in a navigation mode in some embodiments. The system 100 is configured to generate a sequence of images, which are encoded and delivered to an output device in real time or very near real time by leveraging low latency 5G connectivity. In implementations where bandwidth is not sufficient to support delivery of video, and/or a connection is lost, the system 100 is configured to change display to a traditional navigation screen during the low bandwidth or lost connection state. The system 100 is thus configured to allow the user to continue to receive turn-by-turn directions even without sufficient bandwidth and/or mobile connectivity. In some embodiments, at least one of a number of objects in the image, a number of layers in the image, a level of motion parallax, combinations of the same, or the like are removed depending on available processing bandwidth and/or utilized processing load in order to improve video encoding efficiency by reducing an amount of change from one frame to the next.

In some embodiments, the system 100 is configured to include ultra-low latency transport for encoded video for a sequence of AI-generated images. The system 100 is configured to implement such functionality in a manner similar to low latency streaming of video game cloud rendering as disclosed and enabled in U.S. patent application Ser. Nos. 17/721,871 and 17/721,874, both titled “Systems and Methods for Efficient Management of Resources for Streaming Interactive Multimedia Content,” both filed Apr. 15, 2022, which are hereby incorporated by reference herein in their entireties.

In some embodiments, the system 100 is configured to, in response to a change, generate AI prompts, and update the mapping application 192. The change includes at least one of a change in location, a change in a zoom level, a change in a tilt within the mapping application 192, a change in a center point of the map, a change in the location of a map layer object, a change in a user location based on GPS, a change of an object representing a device location, combinations of the same, or the like. The update occurs at the layer level in some embodiments.

The system 100 includes a zoom event listener for interactive mapping applications in some embodiments. The zoom event listener is configured to “listen” to (i.e., detect) zoom events occurring in the mapping application 192, e.g., to detect when a user zooms in or out on the map or when an application automatically zooms in and out in accordance with its programming. When such an event is detected, the zoom event listener is configured to transmits a response including one or more of the methods and processes disclosed herein, such as performing an action or updating the mapping application 192. For example, an application is configured to display different levels of detail based on a zoom level of a map. When the map is zoomed out, the application displays only country borders. When the map is zoomed in, the application displays state and/or province borders, city names, and the like. The zoom event listener is configured to detect when the user has zoomed the map in or out and trigger the application to update the level of detail displayed. That is, in some embodiments, the mapping application 192 is configured to, in response to detection of a zoom trigger, cause the prompt generator 156 to generate generative AI prompts as noted herein.

Returning to the examples depicted in FIGS. 7A-7E, drive-through wait times are determined, for example, by data transmitted by a mapping application 192 and/or by the POI itself. That is, the live source data 132 includes a system remotely or locally managed by an owner and/or operator of the Chick-fil-a location depicted in FIGS. 7A-7E, and/or the data is provided by the mapping application 192 (e.g., Google's generation of information including popular times, wait times, visit duration, and the like).

The system 100 is configured to perform at least one of listening for a zoom event, getting a current zoom level and a center, fetching POI data, logging the zoom level, fetching additional data, generating an image, handling the generated image, handling errors, fetching POI data function, outputting a result, combinations of the same, or the like. The system 100, utilizing the zoom event listener, is configured to execute, for example, Javascript code for a mapping application 192, such as the following:

```
map.on(‘zoom’, function( ) {
// Get the current zoom level and center
let zoomLevel = map.getZoom( );
let center = map.getCenter( );
console.log(‘Zoom level has changed to:’, zoomLevel);
  // Fetch POI from the map zoomed location
  getPOIFromLocation(center.lat, center.lng)
  .then(poi => {
    console.log(‘POI data:’, poi);
//This may result in a wait times URL like:
//poi.waitTimesUrl: https://api.chickfila.com/waittimes?store_id=243
    let waitTimesData;
    let websiteData;
    let poiImage = map.getImageFromLocation(poi.location, zoomLevel);
//This results in an image like FIG. 7B
    // Call the Wait Times API if the POI has a wait times URL
    if (poi.waitTimesUrl) {
    waitTimesData = fetch(poi.waitTimesUrl)
      .then(response => response.json( ));
    }
    //Fetch additional data from the POI's URL and use it for TTS if it
    //has a TTS URL
    if (poi.websiteUrl) {
      websiteData = fetch(poi.websiteUrl)
        .then(response => response.text( ))
        .then(text => {
        // Send the website data to a language model for summarization
//In this case, opensource Alpaca with LLAMA weights running an AWS
//g5.4Xlarge EC2 instance and exposed via a restful interface
        return fetch(‘https://api.generativetext.adeia.com/summarize’,
{
          method: ‘POST’,
          headers: {
            ‘Content-Type’: ‘application/json’
          },
          body: JSON.stringify({
          text: text
          })
        })
        .then(response => response.json( ));
        });
    }
    // Once all data is fetched, call the Generative Image API
//NOTE that waitTimesData may include data such as the wait time and
//data used by the generative AI to guide it like describing the
//location of the drive-thru as map coordinates which may allow the
//generative AI to better place where the cars are generated.
  return Promise.all([waitTimesData, websiteData, poiImage])
    .then(([waitTimes, waitTimesDriveThruGuide, websiteSummary, image])
=> {
//In this case, stable diffusion running an AWS g5.4Xlarge EC2 instance
//and exposed via a restful interface
    return fetch(‘https://api.generativeimages.adeia.com/image’, {
    method: ‘POST’,
    headers: {
      ‘Content-Type’: ‘application/json’
    },
      body: JSON.stringify({
        zoomLevel: zoomLevel,
        waitTimes: waitTimes,
        waitTimesDriveThruGuide : waitTimes DriveThruGuide
        websiteSummary: websiteSummary,
        image: image
      })
    });
    });
  })
  .then(response => response.blob( ))
  .then(blob => {
  let imageUrl = URL.createObjectURL(blob);
  console.log(‘Generated image:’, imageUrl);
  //Add the generated image to the map at the POI location
  map.addImageToLocation(poi.location, imageUrl);
  })
  .catch(error => console.error(‘Error:’, error));
});
//The result: FIG. 7D
function getPOIFromLocation(lat, lng) {
  return fetch(‘https://api.maps.adeia.com?lat=${lat}&lng=${lng}’)
    .then(response => response.json( ));
}
```

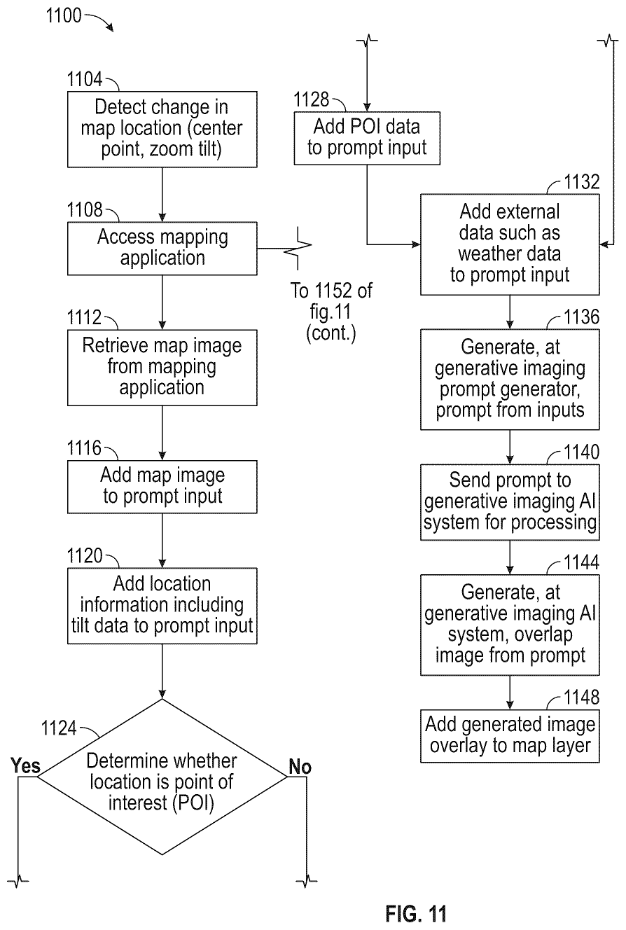

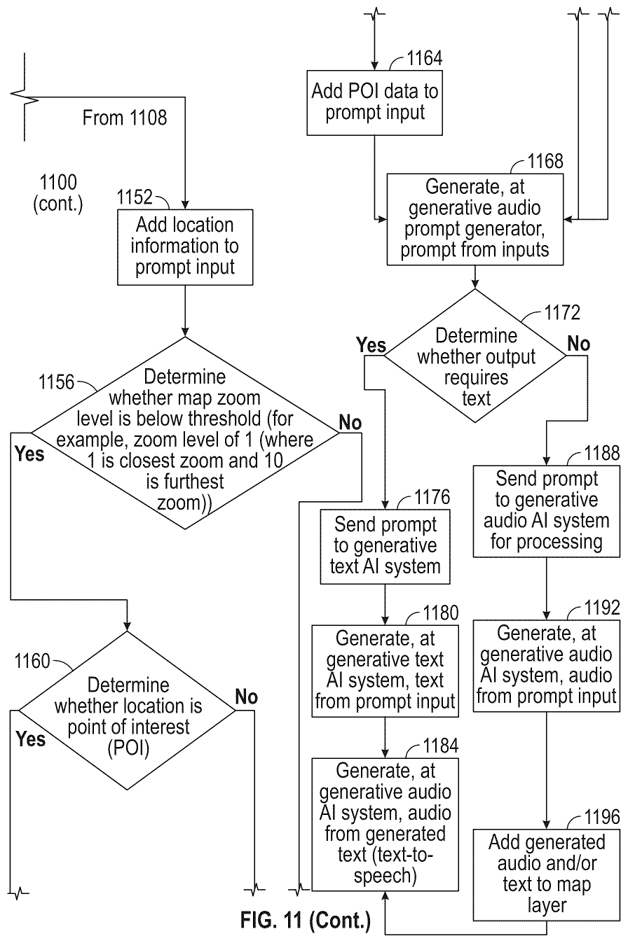

FIG. 11 depicts a process 1100 for re-generating AI prompts, sending the re-generated prompts to the content generator 164 (e.g., one or more generative AI systems), and updating a mapping application 192 with the generated outputs. The process 1100 includes detecting 1104 a change in a map location (e.g., a center point, a zoom, a tilt, or the like). In response to the detecting 1104, the process 1100 includes accessing 1108 a mapping application 192. In response to the accessing 1108, the process 1100 includes retrieving 1112 a map image from the mapping application 192 and, in parallel in some embodiments, adding 1152 (FIG. 11, Cont.) location information to prompt input. In response to the retrieving 1112, the process 1100 includes adding 1116 a map image to the prompt input. In response to the adding 1116, the process 1100 includes adding 1120 the location information including tilt data to the prompt input. In response to the adding 1120, the process 1100 includes determining 1124 whether the location is a POI. In response to determining 1124 the location is a POI (1124=“Yes”), the process 1100 includes adding 1128 POI data to the prompt input. In response to either the adding 1128 or determining 1124 the location is not a POI (1124=“No”), the process 1100 includes adding 1132 external data such as weather data to the prompt input. In response to the adding 1132, the process 1100 includes generating 1136, at the prompt generator 156 (e.g., a generative imaging prompt generator), a prompt from the inputs. In response to the generating 1136, the process 1100 includes sending 1140 the prompt to the content generator 164 (e.g., a generative imaging AI system) for processing. In response to the sending 1140, the process 1100 includes 1144 generating, at the content generator 164 (e.g., the generative imaging AI system), an overlap image from the prompt. In response to the generating 1144, the process 1100 includes adding 1148 the generated image overlay to a map layer. In some embodiments, the process 1100 ends at the adding 1148 step, or the process 1100 continues and adds 1152 location information to the prompt input.

In response to the adding 1152, the process 1100 includes determining 1156 whether a map zoom level is below a threshold. For example, the threshold is 3, where a zoom level is between 1 and 10, where 1 is a closest zoom level, and 10 is the furthest zoom level. In some embodiments, other suitable thresholds and iterations of zoom levels are utilized. In response to determining 1156 whether the map zoom level is below the threshold (1156=“Yes”), the process 1100 includes determining 1160 whether a location is a POI. In response to determining 1160 the location is the POI (1160=“Yes”), the process 1100 includes adding 1164 POI data to the prompt input. Either in response to determining 1156 the map zoom level is equal to or above the threshold (1156=“No”) or determining 1160 the location is not the POI (1160=“No”), or the adding 1164, the process 1100 includes generating 1168, at the content generator (e.g., a generative audio prompt generator), a prompt from inputs. In some embodiments, POI information is added to the prompt input prior to the determining 1156, and the subsequent steps of the process 1100 proceed directly to the generating 1168 step. In other words, steps 1160, 1164, and 1168 are performed between steps 1152 and 1156 in some embodiments. In some embodiments, where no audio is desired, requested or available, step 1168 is skipped or omitted. In response to the generating 1168, the process 1100 includes determining 1172 whether output requires text. In response to determining 1172 the output requires text (1172=“Yes”), the process 1100 includes sending 1176 the prompt to the content generator 164 (e.g., a generative text AI system). In response to the sending 1176, the process 1100 includes generating 1180, at the content generator 164 (e.g., the generative text AI system), text from the prompt input. In response to the generating 1180, the process 1100 includes generating 1184, at the content generator 164 (e.g., a generative audio AI system), audio generated from the generated text (e.g., using a text-to-speech converter). In response to determining 1172 the output does not require text (1172=“No”), the process 1100 includes sending 1188 the prompt to the content generator (e.g., the generative audio AI system) for processing. In response to the sending 1188, the process 1100 includes generating 1192, at the content generator 164 (e.g., the generative audio AI system), audio from the prompt input. Either in response to the generating 1184 or the generating 1192, the process 1100 includes adding 1196 the generated audio and/or the generated text to a map layer. In some embodiments, the process 1100 ends at the adding 1196 step.

In some embodiments, generated audio is automatically played by a mapping application 192 when a user zooms to, selects or approaches a given location (for example when used within a mapped driving session) or when a user zooms to or causes a mapping application 192 to change to a street view. This embodiment does not necessarily require a generative AI to produce audio. Audio could be pre-recorded by an establishment such as a restaurant and provided to the mapping application. For example, a restaurant could provide ambient sounds of what their restaurant sounds like when busy (e.g., for an Irish pub, audio of traditional Irish music playing live is provided). Another example includes adding audio of an executive chef of the restaurant associated with the POI explaining the current menu, items, or specials.

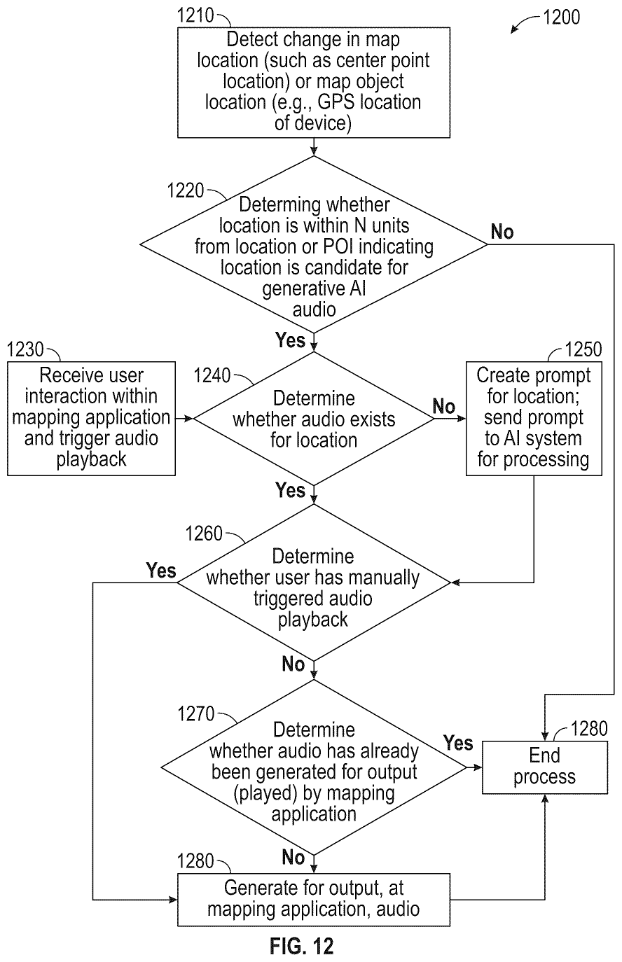

FIG. 12 depicts a process 1200 for automatically playing generated audio added to a mapping application 192 by the system 100. The process 1200 includes detecting 1210 a change in a map location (e.g., a center point location) or a map object location (e.g., a GPS location of a device connected to the system 100). In response to the detecting 1210, the process 1200 includes determining 1220 whether the location is within N units from the location or a POI indicating the location is a candidate for generative AI audio. The process 1200 includes receiving 1230 a user interaction within the mapping application 192 and triggering audio playback. Either in response to the determining 1220 the location is within N units from the location or the POI indicating the location is the candidate for the generative AI audio (1220= “Yes”), or the receiving 1230, the process 1200 includes determining 1240 whether audio exists for the location.

In response to the determining 1240 audio does not exist for the location (1240=“No”), the process 1200 includes creating 1250 a prompt for the location and sending the prompt to the content generator 164 (e.g., an AI system) for processing. In some embodiments, the creating 1250 of the prompt for the location and sending the prompt to the content generator 164 for processing includes generating a prompt for audio generation and generating corresponding text. Either in response to the determining 1240 audio exists for the location (1240=“Yes”), or the creating 1250, the process 1200 includes determining 1260 whether the user has manually triggered audio playback. In response to the determining 1260 the user has not manually triggered audio playback (1260=“No”), the process 1200 includes determining 1270 whether audio has already been generated for output (e.g., played) by the mapping application 192. Either in response to the determining 1260 the user has manually triggered audio playback (1260=“Yes”), or in response to the determining 1270 that audio has not already been generated for output (e.g., played) by the mapping application 192 (1270=“No”), the process 1200 includes generating 1280 for output, at the mapping application 192, audio. Either in response to the determining 1220 the location is not within N units from the location or the POI indicating the location is the candidate for the generative AI audio (1220=“No”), or in response to the determining 1270 that audio has already been generated for output (e.g., played) by the mapping application 192 (1270=“Yes”), or in response to the generating 1280, the process 1200 includes ending 1290 the process 1200.

In some embodiments, the content generator 164 (e.g., a generative AI system) is configured to adjust street view images, which are associated with a location and local weather within the mapping application 192. In some embodiments, the adjustment occurs in a similar way to previous embodiments with the images fetched from the mapping application 192 and sent to the content generator 164 (e.g., the generative AI system) for prompt generation to be used as inputs to a generative AI imaging system. In some embodiments, adjustment of street view images is triggered by a zoom to a specific zoom level and/or by a user selection to view a street view.

For example, a street view image taken during the day is adjusted based on a current time of day and current weather. FIG. 13A depicts a street view image 1300 of a location. The image 1300 of FIG. 13A corresponds to 2:31 p.m. local time with partly cloudy skies. The image 1300 is adjusted in real time through AI prompting and the resulting “night” image 1350 is shown in FIG. 13B, which is rendered at 8:47 p.m. with clear skies. In some embodiments, data such as operating hours indicate that the depicted restaurant is open or closed, and an overlay generation prompt is adjusted based on such information. For example, the system 100 is configured to generate the image 1350 including at least one of a general image overlay 1352 modifying the original image 1300 (e.g., depicting the location as it would generally appear at night around 8:47 p.m. with a dark sky and stars, without shadows, and the like), a weather image 1354 (e.g., a full moon) determined to be accurate for a current date and time (e.g., 8:47 p.m.) corresponding to the image 1350, an object overlay 1356 (e.g., a business sign and lights inside the restaurant), a removed object modification layer 1358 (e.g., removal of vehicles that are present in the image 1300 that are removed due to the depicted time of day being after operating hours), combinations of the same, or the like.

In some embodiments, image resolution and pixelation data are added to the prompt generation system in order to generate outputs that are of the same resolution and/or pixelation as the area or map overlay location. Pixelation is detected using a grey-scale Sobel edge detection filter, for example.

In some instances, an available street view map lags behind (in time) relative to arial and/or satellite imagery. The system 100 is configured to construct images in a manner that does not place a high burden on any related system or user. That is, the system 100 is configured to avoid a tedious manual image construction, such as creating a street view from images obtained by users driving with cameras mounted on cars to capture video subsequently used to generate one or more street view images. The tedious manual construction resulted in old data, particularly for areas outside of large cities. For instance, street view data has not been captured for many county roads (a.k.a. local roads as compared to primary (e.g., freeways), secondary (e.g., arterial), and tertiary (e.g., collector/distributor) roads). In other words, the system 100 is configured to generate simulated real-time imagery for areas that do not have recently captured imagery, such as for local roads outside major metropolitan and/or highly populated areas.

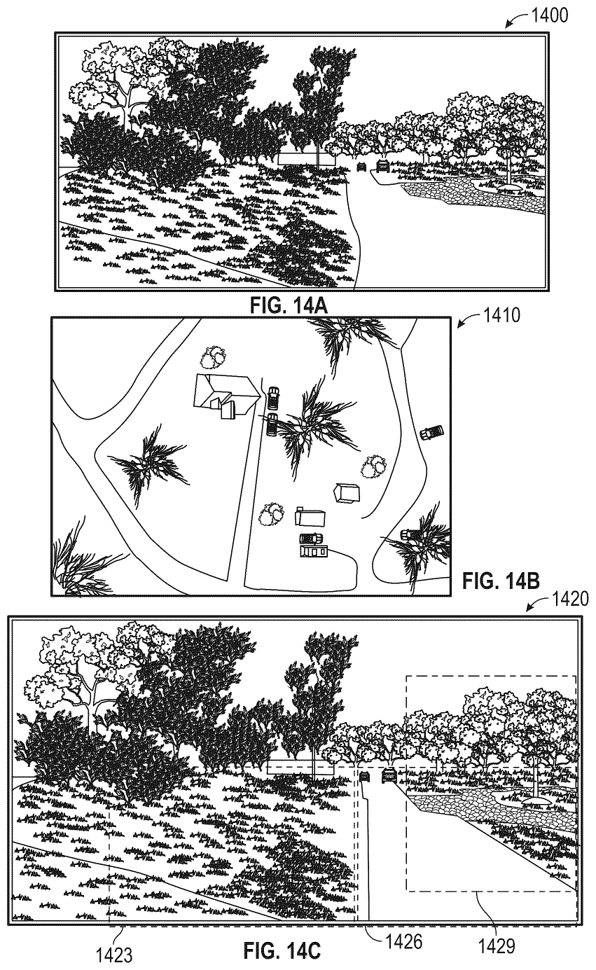

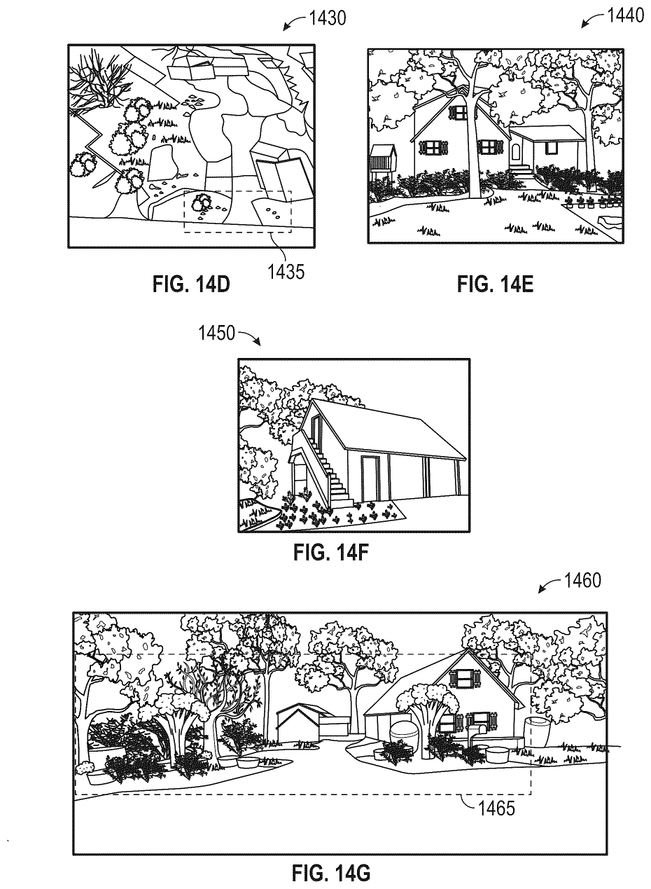

For example, FIGS. 14A and 14B demonstrate differences from a street view map image 1400 of a given address (FIG. 14A) and a satellite map image 1410 (FIG. 14B) of the same address. In this example, the street view map image 1400 (circa 2011) is about 11 years older than the satellite map image 1410 (circa 2022). In some embodiments, the system 100 is configured to utilize the satellite image 1410 to update the older street view image 1400, to adjust the street view image 1400 to appear to be more up-to-date, reflecting changes detected by the relatively newer satellite image 1410.

Generative AI is utilized to leverage satellite imagery along with other data for generating a new, updated street view image based on updated data. For example, FIG. 14C depicts an updated street view image 1420 updated via AI prompting with both street view image 1400 and the satellite image 1410 as inputs along with time of day, temperature, and season. That is, the updated image 1420 includes overlays that update the street view data to better represent changes since the image 1400 was taken. In addition, updated street view data is generated for locations where street view data does not exist or is unavailable. For example, the image 1420 includes at least one of a first updated landscaping layer 1423, an updated roadway layer 1426, and a second updated landscaping layer 1429, combinations of the same, or the like. The first layer 1423 includes removal of objects (e.g., a landscaping feature) identified in the original image 1400 that no longer appear in the satellite image 1410 and replacement with objects (e.g., grass) that appear in the satellite image 1410. The roadway layer 1426 includes a rendering of the driveway identified in the satellite image 1410 that did not appear in the original image 1400. The second landscaping layer 1429 includes a rendering of objects (e.g., new grass and a new tree) identified in the satellite image 1410 that did not appear in the original image 1400. These layers are merely exemplary and other types of modifications may be made to transform the input imagery into output imagery.

In another example, FIG. 14D depicts a satellite image 1430 (circa 2009) of a location where more recent street view data does not exist or is not accessible. FIG. 14E and FIG. 14F are images 1440, 1450 from tax records for the same address with no street data from the satellite image 1430 taken in 2009. The images 1430, 1440, 1450 are provided as input. FIG. 14G is an example of an output image 1460 resulting from the system 100 configured to generate a street view leveraging intermediate input information including at least one of generative AI, live weather information, live time of day information, seasonal information, satellite imagery, county records, time and/or date of the input image, combinations of the same, or the like. The intermediate input is adjusted to simulate the appearance of plant growth changes occurring or likely to occur between the input date(s) to a current date. The output image 1460 includes an overlay 1465 based on the processed inputs. For example, an area 1435 of the image 1430 encloses several objects (e.g., bushes and small trees) identified in the image 1430 at a first point of time corresponding to a date of the image 1430. The overlay 1465 of the output image 1460 renders the identified objects in the area 1435 as appropriate for a street view and advanced in time to represent a difference in time between the first point of time corresponding to the date of the image 1430 and a current date of rendering the image 1460.

In one embodiment, the system 100 is configured to generate with the content generator 164 (e.g., a generative image AI system) a plurality of images of a street view, where each image of the plurality of images is updated in sequence to simulate the street view of the location at a current time. The integrator 180 is configured to utilize the plurality of images to generate a new viewing user experience (UX) in which directions (e.g., FIG. 10A) are shown of a street view (e.g., FIG. 10B) that is updated via the prompt to match the environment. The generated sequence of images is streamed to a viewing device in some embodiments.

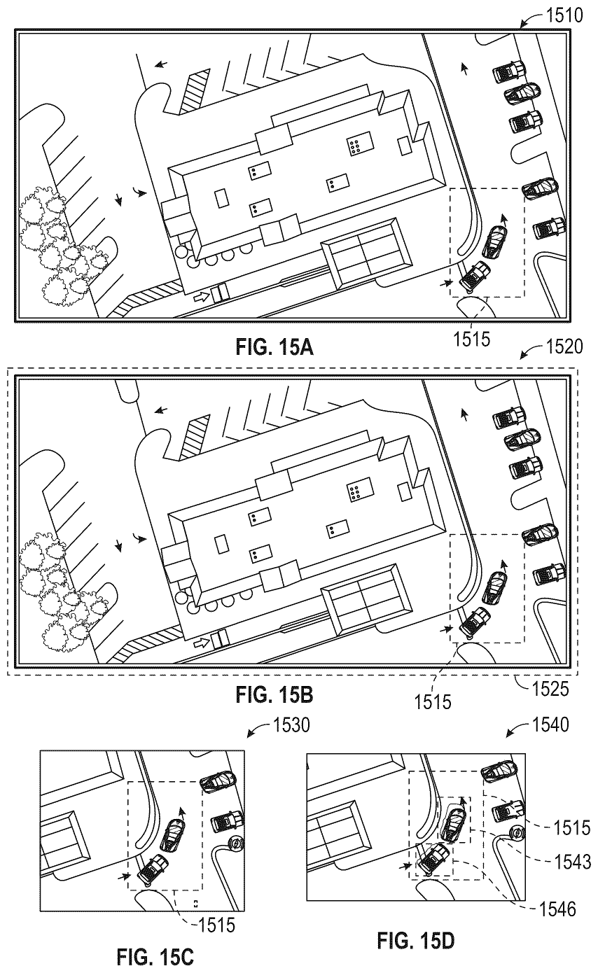

FIG. 15A depicts an image 1510 without adjustment, e.g., without including pixelation or resolution of source images in the prompt generation. The image 1510 includes a layer 1515 rendering a pair of vehicles not originally depicted in an input image. FIG. 15B depicts an image 1520 including adjustment of pixelation and/or resolution data.

In some embodiments, shadow length and direction are calculated. The shadow length and direction are calculated, for example, using a Python-based process of extracting pixels of a shadow in an image to calculate length and the like. The information regarding the shadow generated by the Python-based process is added to intermediate data passed to the prompt generator 156 for prompting the content generator 164 to include shadows that match those within a same area of the map or POI location as that depicted in FIG. 15A.

FIG. 15C depicts a portion 1530 of the map image 1510 of the business from the mapping application with the overlay 1515 of the rendered objects. FIG. 15D depicts a portion 1540 with the overlay 1515 of the rendered objects and with rendered shadows 1543, 1546 for the rendered objects. The rendered shadows 1543, 1546 are rendered based on a shadow calculation that is pre-determined by the mapping application, and/or with an instruction to calculate data from an original image (e.g., image 1510) passed to the AI prompt generator. Predictive Model

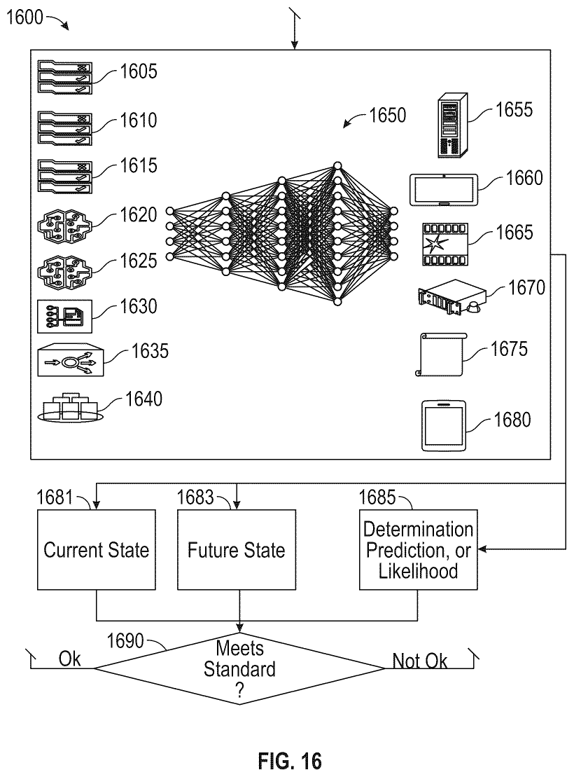

Throughout the present disclosure, in some embodiments, determinations, predictions, likelihoods, and the like are determined with one or more predictive models. For example, FIG. 16 depicts a predictive model. A prediction process 1600 includes a predictive model 1650 in some embodiments. The predictive model 1650 receives as input various forms of data about one, more or all the users, media content items, devices, and data described in the present disclosure. The predictive model 1650 performs analysis based on at least one of hard rules, learning rules, hard models, learning models, usage data, load data, analytics of the same, metadata, or profile information, and the like. The predictive model 1650 outputs one or more predictions of a future state of any of the devices described in the present disclosure. A load-increasing event is determined by load-balancing processes, e.g., least connection, least bandwidth, round robin, server response time, weighted versions of the same, resource-based processes, and address hashing. The predictive model 1650 is based on input including at least one of a hard rule 1605, a user-defined rule 1610, a rule defined by a content provider 1615, a hard model 1620, or a learning model 1625.

The predictive model 1650 receives as input usage data 1630. The predictive model 1650 is based, in some embodiments, on at least one of a usage pattern of the user or media device, a usage pattern of the requesting media device, a usage pattern of the media content item, a usage pattern of the communication system or network, a usage pattern of the profile, or a usage pattern of the media device.

The predictive model 1650 receives as input load-balancing data 1635. The predictive model 1650 is based on at least one of load data of the display device, load data of the requesting media device, load data of the media content item, load data of the communication system or network, load data of the profile, or load data of the media device.

The predictive model 1650 receives as input metadata 1640. The predictive model 1650 is based on at least one of metadata of the streaming service, metadata of the requesting media device, metadata of the media content item, metadata of the communication system or network, metadata of the profile, or metadata of the media device. The metadata includes information of the type represented in the media device manifest.

The predictive model 1650 is trained with data. The training data is developed in some embodiments using one or more data processes including but not limited to data selection, data sourcing, and data synthesis. The predictive model 1650 is trained in some embodiments with one or more analytical processes including but not limited to classification and regression trees (CART), discrete choice models, linear regression models, logistic regression, logit versus probit, multinomial logistic regression, multivariate adaptive regression splines, probit regression, regression processes, survival or duration analysis, and time series models. The predictive model 1650 is trained in some embodiments with one or more machine learning approaches including but not limited to supervised learning, unsupervised learning, semi-supervised learning, reinforcement learning, and dimensionality reduction. The predictive model 1650 in some embodiments includes regression analysis including analysis of variance (ANOVA), linear regression, logistic regression, ridge regression, and/or time series. The predictive model 1650 in some embodiments includes classification analysis including decision trees and/or neural networks. In FIG. 16, a depiction of a multi-layer neural network is provided as a non-limiting example of a predictive model 1650, the neural network including an input layer (left side), three hidden layers (middle), and an output layer (right side) with 32 neurons and 192 edges, which is intended to be illustrative, not limiting. The predictive model 1650 is based on data engineering and/or modeling processes. The data engineering processes include exploration, cleaning, normalizing, feature engineering, and scaling. The modeling processes include model selection, training, evaluation, and tuning. The predictive model 1650 is operationalized using registration, deployment, monitoring, and/or retraining processes.

The predictive model 1640 is configured to output results to a device or multiple devices. The device includes means for performing one, more, or all the features referenced herein of the systems, methods, processes, and outputs of one or more of FIGS. 1-15, in any suitable combination. The device is at least one of a server 1655, a tablet 1660, a media display device 1665, a network-connected computer 1670, a media device 1675, a computing device 1680, or the like.

The predictive model 1650 is configured to output a current state 1681, and/or a future state 1683, and/or a determination, a prediction, or a likelihood 1685, and the like. The current state 1681, and/or the future state 1683, and/or the determination, the prediction, or the likelihood 1685, and the like may be compared 1690 to a predetermined or determined standard. In some embodiments, the standard is satisfied (1490=OK) or rejected (1490=NOT OK). If the standard is satisfied or rejected, the predictive process 1600 outputs at least one of the current state, the future state, the determination, the prediction, or the likelihood to any device or module disclosed herein.

### Communication System

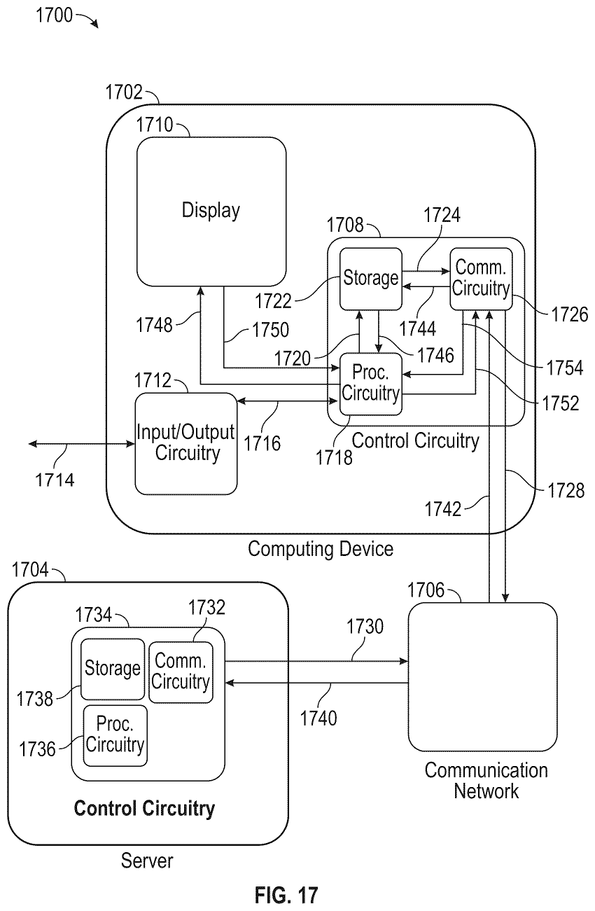

FIG. 17 depicts a block diagram of system 1700, in accordance with some embodiments. The system is shown to include computing device 1702, server 1704, and a communication network 1706. It is understood that while a single instance of a component may be shown and described relative to FIG. 17, additional embodiments of the component may be employed. For example, server 1704 may include, or may be incorporated in, more than one server. Similarly, communication network 1706 may include, or may be incorporated in, more than one communication network. Server 1704 is shown communicatively coupled to computing device 1702 through communication network 1706. While not shown in FIG. 17, server 1704 may be directly communicatively coupled to computing device 1702, for example, in a system absent or bypassing communication network 1706.

Communication network 1706 may include one or more network systems, such as, without limitation, the Internet, LAN, Wi-Fi, wireless, or other network systems suitable for audio processing applications. The system 1700 of FIG. 17 excludes server 1704, and functionality that would otherwise be implemented by server 1704 is instead implemented by other components of the system depicted by FIG. 17, such as one or more components of communication network 1706. In still other embodiments, server 1704 works in conjunction with one or more components of communication network 1706 to implement certain functionality described herein in a distributed or cooperative manner. Similarly, the system depicted by FIG. 17 excludes computing device 1702, and functionality that would otherwise be implemented by computing device 1702 is instead implemented by other components of the system depicted by FIG. 17, such as one or more components of communication network 1706 or server 1704 or a combination of the same. In other embodiments, computing device 1702 works in conjunction with one or more components of communication network 1706 or server 1704 to implement certain functionality described herein in a distributed or cooperative manner.

Computing device 1702 includes control circuitry 1708, display 1710 and input/output (I/O) circuitry 1712. Control circuitry 1708 may be based on any suitable processing circuitry and includes control circuits and memory circuits, which may be disposed on a single integrated circuit or may be discrete components. As referred to herein, processing circuitry should be understood to mean circuitry based on at least one microprocessors, microcontrollers, digital signal processors, programmable logic devices, field-programmable gate arrays (FPGAs), or application-specific integrated circuits (ASICs), and the like, and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). Some control circuits may be implemented in hardware, firmware, or software. Control circuitry 1708 in turn includes communication circuitry 1726, storage 1722 and processing circuitry 1718. Either of control circuitry 1708 and 1734 may be utilized to execute or perform any or all the systems, methods, processes, and outputs of one or more of FIGS. 1-16, or any combination of steps thereof (e.g., as enabled by processing circuitries 1718 and 1736, respectively).

In addition to control circuitry 1708 and 1734, computing device 1702 and server 1704 may each include storage (storage 1722, and storage 1738, respectively). Each of storages 1722 and 1738 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 8D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 1722 and 1738 may be used to store several types of content, metadata, and/or other types of data. Non-volatile memory may also be used (e.g., to launch a boot-up routine and other instructions). Cloud-based storage may be used to supplement storages 1722 and 1738 or instead of storages 1722 and 1738. In some embodiments, a user profile and messages corresponding to a chain of communication may be stored in one or more of storages 1722 and 1738. Each of storages 1722 and 1738 may be utilized to store commands, for example, such that when each of processing circuitries 1718 and 1736, respectively, are prompted through control circuitries 1708 and 1734, respectively. Either of processing circuitries 1718 or 1736 may execute any of the systems, methods, processes, and outputs of one or more of FIGS. 1-16, or any combination of steps thereof.

In some embodiments, control circuitry 1708 and/or 1734 executes instructions for an application stored in memory (e.g., storage 1722 and/or storage 1738). Specifically, control circuitry 1708 and/or 1734 may be instructed by the application to perform the functions discussed herein. In some embodiments, any action performed by control circuitry 1708 and/or 1734 may be based on instructions received from the application. For example, the application may be implemented as software or a set of and/or one or more executable instructions that may be stored in storage 1722 and/or 1738 and executed by control circuitry 1708 and/or 1734. The application may be a client/server application where only a client application resides on computing device 1702, and a server application resides on server 1704.

The application may be implemented using any suitable architecture. For example, it may be a stand-alone application wholly implemented on computing device 1702. In such an approach, instructions for the application are stored locally (e.g., in storage 1722), and data for use by the application is downloaded on a periodic basis (e.g., from an out-of-band feed, from an Internet resource, or using another suitable approach). Control circuitry 1708 may retrieve instructions for the application from storage 1722 and process the instructions to perform the functionality described herein. Based on the processed instructions, control circuitry 1708 may determine a type of action to perform in response to input received from I/O circuitry 1712 or from communication network 1706.

In client/server-based embodiments, control circuitry 1708 may include communication circuitry suitable for communicating with an application server (e.g., server 1704) or other networks or servers. The instructions for conducting the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 1706). In another example of a client/server-based application, control circuitry 1708 runs a web browser that interprets web pages provided by a remote server (e.g., server 1704). For example, the remote server may store the instructions for the application in a storage device.

The remote server may process the stored instructions using circuitry (e.g., control circuitry 1734) and/or generate displays. Computing device 1702 may receive the displays generated by the remote server and may display the content of the displays locally via display 1710. For example, display 1710 may be utilized to present a string of characters. This way, the processing of the instructions is performed remotely (e.g., by server 1704) while the resulting displays, such as the display windows described elsewhere herein, are provided locally on computing device 1704. Computing device 1702 may receive inputs from the user via input/output circuitry 1712 and transmit those inputs to the remote server for processing and generating the corresponding displays.

Alternatively, computing device 1702 may receive inputs from the user via input/output circuitry 1712 and process and display the received inputs locally, by control circuitry 1708 and display 1710, respectively. For example, input/output circuitry 1712 may correspond to a keyboard and/or a set of and/or one or more speakers/microphones which are used to receive user inputs (e.g., input as displayed in a search bar or a display of FIG. 17 on a computing device). Input/output circuitry 1712 may also correspond to a communication link between display 1710 and control circuitry 1708 such that display 1710 updates in response to inputs received via input/output circuitry 1712 (e.g., simultaneously update what is shown in display 1710 based on inputs received by generating corresponding outputs based on instructions stored in memory via a non-transitory, computer-readable medium).

Server 1704 and computing device 1702 may transmit and receive content and data such as media content via communication network 1706. For example, server 1704 may be a media content provider, and computing device 1702 may be a smart television configured to download or stream media content, such as a live news broadcast, from server 1704. Control circuitry 1734, 1708 may send and receive commands, requests, and other suitable data through communication network 1706 using communication circuitry 1732, 1726, respectively. Alternatively, control circuitry 1734, 1708 may communicate directly with each other using communication circuitry 1732, 1726, respectively, avoiding communication network 1706.

It is understood that computing device 1702 is not limited to the embodiments and methods shown and described herein. In nonlimiting examples, computing device 1702 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or combination of the same, capable of suitably displaying and manipulating media content.

Computing device 1702 receives user input 1714 at input/output circuitry 1712. For example, computing device 1702 may receive a user input such as a user swipe or user touch. It is understood that computing device 1702 is not limited to the embodiments and methods shown and described herein.

User input 1714 may be received from a user selection-capturing interface that is separate from device 1702, such as a remote-control device, trackpad, or any other suitable user movement-sensitive, audio-sensitive or capture devices, or as part of device 1702, such as a touchscreen of display 1710. Transmission of user input 1714 to computing device 1702 may be accomplished using a wired connection, such as an audio cable, USB cable, ethernet cable and the like attached to a corresponding input port at a local device, or may be accomplished using a wireless connection, such as Bluetooth, Wi-Fi, WiMAX, GSM, UTMS, CDMA, TDMA, 8G, 4G, 4G LTE, 5G, or any other suitable wireless transmission protocol. Input/output circuitry 1712 may include a physical input port such as a 12.5 mm (0.4921 inch) audio jack, RCA audio jack, USB port, ethernet port, or any other suitable connection for receiving audio over a wired connection or may include a wireless receiver configured to receive data via Bluetooth, Wi-Fi, WiMAX, GSM, UTMS, CDMA, TDMA, 3G, 4G, 4G LTE, 5G, or other wireless transmission protocols.

Processing circuitry 1718 may receive user input 1714 from input/output circuitry 1712 using communication path 1716. Processing circuitry 1718 may convert or translate the received user input 1714 that may be in the form of audio data, visual data, gestures, or movement to digital signals. In some embodiments, input/output circuitry 1712 performs the translation to digital signals. In some embodiments, processing circuitry 1718 (or processing circuitry 1736, as the case may be) conducts disclosed processes and methods.

Processing circuitry 1718 may provide requests to storage 1722 by communication path 1720. Storage 1722 may provide requested information to processing circuitry 1718 by communication path 1746. Storage 1722 may transfer a request for information to communication circuitry 1726 which may translate or encode the request for information to a format receivable by communication network 1706 before transferring the request for information by communication path 1728. Communication network 1706 may forward the translated or encoded request for information to communication circuitry 1732, by communication path 1730.

At communication circuitry 1732, the translated or encoded request for information, received through communication path 1730, is translated or decoded for processing circuitry 1736, which will provide a response to the request for information based on information available through control circuitry 1734 or storage 1738, or a combination thereof. The response to the request for information is then provided back to communication network 1706 by communication path 1740 in an encoded or translated format such that communication network 1706 forwards the encoded or translated response back to communication circuitry 1726 by communication path 1742.

At communication circuitry 1726, the encoded or translated response to the request for information may be provided directly back to processing circuitry 1718 by communication path 1754 or may be provided to storage 1722 through communication path 1744, which then provides the information to processing circuitry 1718 by communication path 1746. Processing circuitry 1718 may also provide a request for information directly to communication circuitry 1726 through communication path 1752, where storage 1722 responds to an information request (provided through communication path 1720 or 1744) by communication path 1724 or 1746 that storage 1722 does not contain information pertaining to the request from processing circuitry 1718.

Processing circuitry 1718 may process the response to the request received through communication paths 1746 or 1754 and may provide instructions to display 1710 for a notification to be provided to the users through communication path 1748. Display 1710 may incorporate a timer for providing the notification or may rely on inputs through input/output circuitry 1712 from the user, which are forwarded through processing circuitry 1718 through communication path 1748, to determine how long or in what format to provide the notification. When display 1710 determines the display has been completed, a notification may be provided to processing circuitry 1718 through communication path 1750.

The communication paths provided in FIG. 17 between computing device 1702, server 1704, communication network 1706, and all subcomponents depicted are examples and may be modified to reduce processing time or enhance processing capabilities for each step in the processes disclosed herein by one skilled in the art.

### Conversational Interaction System

In some embodiments, one or more of system 100, system 1600, or system 1700 includes the conversational interaction system 188. The conversational interaction system 188 is configured to perform a method of inferring a change of a conversation session during continuous user interaction with an interactive content providing system having a processor, the method comprising: providing access to a set of content items, each of the content items having associated metadata stored in an electronically readable medium that describes the corresponding content item; receiving at the processor a first input from a user, the first input including linguistic elements intended by the user to identify at least one desired content item; associating by the processor at least one linguistic element of the first input with a first conversation session; providing by the processor a first response based on the first input and based on the metadata associated with the content items; receiving at the processor a second input from the user; inferring by the processor whether or not the second input from the user is related to the at least one linguistic element associated with the first conversation session; upon a condition in which the second input is inferred to relate to the at least one linguistic element associated with the first conversation session, providing by the processor a second response based on the metadata associated with the content items, the second input, and the at least one linguistic element of the first input associated with the first conversation session; and upon a condition in which the second input is inferred to not relate to the at least one linguistic element associated with the first conversation session, providing by the processor a second response based on the metadata associated with the content items and the second input.

In some embodiments, one or more of system 100, system 1600, or system 1700 includes a computer-implemented method of inferring a change of a conversation session during continuous user interaction with an interactive content providing system having one or more processors, the method comprising: providing access to a set of content items, each of the content items having associated metadata stored in an electronically readable medium that describes the corresponding content item; receiving at one or more of the processors a first input from a user, the first input including linguistic elements intended by the user to identify at least one desired content item; associating by one or more of the processors at least one linguistic element of the first input with a first conversation session; providing by one or more of the processors a first response based on the first input and based on the metadata associated with the content items; receiving at one or more of the processors a second input from the user; inferring by one or more of the processors whether or not the second input from the user is related to the at least one linguistic element associated with the first conversation session; upon a condition in which the second input is inferred to relate to the at least one linguistic element associated with the first conversation session, providing by one or more of the processors a second response based on the metadata associated with the content items, the second input, and the at least one linguistic element of the first input associated with the first conversation session; and upon a condition in which the second input is inferred to not relate to the at least one linguistic element associated with the first conversation session, providing by one or more of the processors a second response based on the metadata associated with the content items and the second input.

In some embodiments, one or more of system 100, system 1600, or system 1700 is configured to perform a method of inferring user intent in a search input based on resolving ambiguous portions of the search input, the method comprising: providing access to a set of content items, each of the content items being associated with metadata that describes the corresponding content item; providing a user preference signature, the user preference signature describing preferences of the user for at least one of (i) particular content items and (ii) metadata associated with the content items; receiving search input from the user, the search input being intended by the user to identify at least one desired content item; determining a state space associated with the set of content items and with at least a portion of the search input, wherein the state space includes entities and relationships between the entities; determining that a portion of the search input contains an ambiguous identifier, the ambiguous identifier intended by the user to identify, at least in part, the at least one desired content item; inferring a meaning for the ambiguous identifier by performing the following: determining whether an entity and a relationship in the state space disambiguates the ambiguous identifier, upon a condition that at least one of the entity and the relationship in the state space disambiguates the ambiguous identifier, the inferring the meaning for the ambiguous identifier being based at least in part on the at least one of the entity and the relationship in the state space that disambiguates the ambiguous identifier, upon a condition that the at least one of the entity and the relationship in the state space does not disambiguate the ambiguous identifier, the inferring the meaning for the ambiguous identifier including formulating and presenting a follow-up conversational question formed in part based on selecting at least one response template, wherein the at least one response template is selected based at least in part on matching characteristics of at least one of entities and relationships along a path that includes an entity and a relationship that matches portions of the search input to the preferences of the user described by the user preference signature; determining, based on the state space, whether the search input is related to a portion of a previously received search input; and in response to determining that the search input is not related to the portion of the previously-received search input, selecting content items from the set of content items based on comparing the search input and the inferred meaning of the ambiguous identifier with metadata associated with the content items and further based on disregarding entities related to the portion of the previously-received search input.

In some embodiments, one or more of system 100, system 1600, or system 1700 is configured to perform a method of inferring user intent in a search input based on resolving ambiguous portions of the search input, the method comprising: providing access to a set of content items, each of the content items being associated with metadata that describes the corresponding content item; receiving search input from the user, the search input being intended by the user to identify at least one desired content item; determining a state space associated with the set of content items and with at least a portion of the search input, wherein the state space includes entities and relationships between the entities; determining whether or not a portion of the search input contains an ambiguous identifier, the ambiguous identifier intended by the user to identify, at least in part, the at least one desired content item; upon a condition in which a portion of the search input contains an ambiguous identifier, performing the following: determining whether at least one of an entity and a relationship in the state space disambiguates the ambiguous identifier, upon the condition that at least one of the entity and the relationship in the state space disambiguates the ambiguous identifier, inferring a meaning for the ambiguous identifier based at least in part on the at least one of the entity and the relationship in the state space that disambiguates the ambiguous identifier, and selecting content items from the set of content items based on comparing the search input and the inferred meaning of the ambiguous identifier with metadata associated with the content items; and upon a condition in which the at least one of the entity and the relationship in the state space does not disambiguate the ambiguous identifier, inferring the meaning for the ambiguous identifier including formulating and presenting a follow-up conversational question formed in part based on selecting at least one response template, wherein the at least one response template is selected based at least in part on matching characteristics of at least one of entities and relationships along a path that includes an entity and a relationship that matches portions of the search input to the preferences of the user described by the user preference signature, determining, based on the state space, whether the search input is related to a portion of a previously received search input; and in response to determining that the search input is not related to the portion of the previously-received search input, selecting content items from the set of content items based on comparing the search input and the inferred meaning of the ambiguous identifier with metadata associated with the content items and further based on matching portions of the search input to preferences of the user described by a user preference signature and further based on disregarding entities related to the portion of the previously-received search input.

In some embodiments, one or more of system 100, system 1600, or system 1700 is configured to perform a method of inferring user intent in a search input based on resolving ambiguous portions of the search input, the method comprising: providing access to a set of content items, each of the content items being associated with metadata that describes the corresponding content item, the metadata associated with the content items including a mapping of relationships between entities associated with the content items; receiving search input from a user, the search input being intended by the user to identify at least one desired content item, wherein the search input comprises: a first portion comprising at least one specified entity, and a second portion comprising a reference to at least one unspecified entity related to the at least one desired content item, wherein the at least one unspecified entity of the second portion and the at least one specified entity of the first portion are different; without further user input: inferring a possible meaning for the at least one unspecified entity of the second portion based on the at least one specified entity and the mapping of relationships between entities; based on the inferred possible meaning for the at least one unspecified entity, the at least one specified entity, and the metadata associated with the content items of the set of content items, selecting at least one common content item from the set of content items, wherein the at least one common content item is related to each of the at least one specified entity and the at least one unspecified entity in the mapping of relationships; and presenting the selected at least one common content item to the user in response to the search input received from the user.

In some embodiments, one or more of system 100, system 1600, or system 1700 includes a system for inferring user intent in a search input based on resolving ambiguous portions of the search input comprising: one or more processors configured to: provide access to a set of content items, each of the content items being associated with metadata that describes the corresponding content item, the metadata associated with the content items including a mapping of relationships between entities associated with the content items; receive search input from a user, the search input being intended by the user to identify at least one desired content item, wherein the search input comprises: a first portion comprising at least one specified entity, and a second portion comprising a reference to at least one unspecified entity related to the at least one desired content item, wherein the at least one unspecified entity of the second portion and the at least one specified entity of the first portion are different.

In some embodiments, one or more of system 100, system 1600, or system 1700 is configured to perform a method of inferring a conversation session during continuous user interaction with an interactive content providing system having a processor, the method comprising: providing access to a set of content items, each content item of the set of content items having associated metadata stored in an electronically readable medium that describes the corresponding content item; receiving at the processor a first input from a user, the first input including linguistic elements that identify at least one desired content item from the set of content items; associating by the processor at least one linguistic element of the first input with a first conversation session; providing by the processor a first response based on the first input and based on metadata associated with the set of content items, wherein the first response comprises the at least one desired content item; receiving at the processor a second input from the user; inferring by the processor whether the second input from the user is related to the at least one linguistic element associated with the first conversation session; and upon a condition in which the second input is inferred to relate to the at least one linguistic element associated with the first conversation session, providing by the processor a second response based on metadata associated with the at least one desired content item, the second input, and the at least one linguistic element of the first input associated with the first conversation session.

In some embodiments, one or more of system 100, system 1600, or system 1700 includes a system for inferring a conversation session during continuous user interaction with an interactive content providing system, the system comprising: a processor configured to: provide access to a set of content items, each content item of the set of content items having associated metadata stored in an electronically readable medium that describes the corresponding content item; receive a first input from a user, the first input including linguistic elements that identify at least one desired content item from the set of content items; associate at least one linguistic element of the first input with a first conversation session; provide a first response based on the first input and based on metadata associated with the set of content items, wherein the first response comprises the at least one desired content item; receive a second input from the user; infer whether the second input from the user is related to the at least one linguistic element associated with the first conversation session; and upon a condition in which the second input is inferred to relate to the at least one linguistic element associated with the first conversation session, provide a second response based on metadata associated with the at least one desired content item, the second input, and the at least one linguistic element of the first input associated with the first conversation session.

In some embodiments, one or more of system 100, system 1600, or system 1700 is configured to perform a computer-implemented method of inferring user intent in a search input, the method comprising: receiving a search input from a user at one or more processors, the search input used to identify at least one desired content item of a set of content items, each of the content items being associated with at least one domain; determining by the one or more processors that a first portion of the search input contains a linguistic element that has a plurality of possible meanings; calculating a first weight based on a distance between a first node of a first graph data structure corresponding to the first portion of the search input and a second node of the first graph data structure corresponding to a second portion of the search input, wherein the first graph data structure comprises nodes connected by relationships, and wherein the first graph data structure is relevant to a first domain; calculating a second weight based on a distance between a first node of a second graph data structure corresponding to the first portion of the search input and a second node of the second graph data structure corresponding to the second portion of the search input, wherein the second graph data structure comprises nodes connected by relationships, and wherein the second graph data structure is relevant to a second domain; determining by the one or more processors one of the first domain or the second domain as being a relevant domain to the search input based on a comparison of the first weight and the second weight; selecting by the one or more processors at least one content item from the set of content items based on the search input, the relevant domain, and metadata associated with the content items; and causing to be provided information corresponding to the at least one desired content item.

In some embodiments, one or more of system 100, system 1600, or system 1700 includes a system for inferring user intent in a search input, the system comprising: a processor configured to: receive a search input from a user, the search input used to identify at least one desired content item of a set of content items, each of the content items being associated with at least one domain; determine that a first portion of the search input contains a linguistic element that has a plurality of possible meanings; calculate a first weight based on a distance between a first node of a first graph data structure corresponding to the first portion of the search input and a second node of the first graph data structure corresponding to a second portion of the search input, wherein the first graph data structure comprises nodes connected by relationships, and wherein the first graph data structure is relevant to a first domain; calculate a second weight based on a distance between a first node of a second graph data structure corresponding to the first portion of the search input and a second node of the second graph data structure corresponding to the second portion of the search input, wherein the second graph data structure comprises nodes connected by relationships, and wherein the second graph data structure is relevant to a second domain; determine one of the first domain or the second domain as being a relevant domain to the search input based on a comparison of the first weight and the second weight; select at least one content item from the set of content items based on the search input, the relevant domain, and metadata associated with the content items; and causing to be provided information corresponding to the at least one desired content item.

In some embodiments, one or more of system 100, system 1600, or system 1700 is configured to perform a computer-implemented method of inferring user intent in a search input, the method comprising: receiving a search input from a user at one or more processors, the search input used to identify at least one desired content item of a set of content items, each of the content items being associated with at least one domain; determining by the one or more processors that a first portion of the search input contains a linguistic element that has a plurality of possible meanings; determining a first relationship between a first node of a first graph data structure corresponding to the first portion of the search input and a second node of the first graph data structure corresponding to a second portion of the search input, wherein the first graph data structure is relevant to a first domain; determining a second relationship between a first node of a second graph data structure corresponding to the first portion of the search input and a second node of the second graph data structure corresponding to the second portion of the search input, wherein the second graph data structure is relevant to a second domain; determining by the one or more processors one of the first domain or the second domain as being a relevant domain to the search input based on a comparison of the first relationship and the second relationship; selecting by the one or more processors at least one content item from the set of content items based on the search input, and the relevant domain; and causing to be provided with information corresponding to the at least one desired content item.

In some embodiments, one or more of system 100, system 1600, or system 1700 includes a system for inferring user intent in a search input, the system comprising: a processor configured to: receive a search input from a user at one or more processors, the search input used to identify at least one desired content item of a set of content items, each of the content items being associated with at least one domain; determine by the one or more processors that a first portion of the search input contains a linguistic element that has a plurality of possible meanings; determine a first relationship between a first node of a first graph data structure corresponding to the first portion of the search input and a second node of the first graph data structure corresponding to a second portion of the search input, wherein the first graph data structure is relevant to a first domain; determine a second relationship between a first node of a second graph data structure corresponding to the first portion of the search input and a second node of the second graph data structure corresponding to the second portion of the search input, wherein the second graph data structure is relevant to a second domain; determine by the one or more processors one of the first domain or the second domain as being a relevant domain to the search input based on a comparison of the first relationship and the second relationship; select by the one or more processors at least one content item from the set of content items based on the search input, and the relevant domain; and cause to be provided with information corresponding to the at least one desired content item.

### Terminology

The terminology used herein is for the purpose of describing particular embodiments only and is not intended to be limiting of the disclosure.

As used herein, the terms “real-time,” “real time,” “simultaneous,” “substantially on-demand,” and the like are understood to be nearly instantaneous but may include delay due to practical limits of the system. Such delays may be on the order of milliseconds or microseconds, depending on the application and nature of the processing. Relatively longer delays (e.g., greater than a millisecond) may result due to communication or processing delays, particularly in remote and cloud computing environments.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least some embodiments are described as using a plurality of units or modules to perform a process or processes, it is understood that the process or processes may also be performed by one or a plurality of units or modules. Additionally, it is understood that the term controller/control unit may refer to a hardware device that includes a memory and a processor. The memory may be configured to store the units or the modules, and the processor may be specifically configured to execute said units or modules to perform one or more processes which are described herein.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The use of the terms “first”, “second”, “third”, and so on, herein, are provided to identify structures or operations, without describing an order of structures or operations, and, to the extent the structures or operations are used in an embodiment, the structures may be provided or the operations may be executed in a different order from the stated order unless a specific order is definitely specified in the context.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory (e.g., a non-transitory, computer-readable medium accessible by an application via control or processing circuitry from storage) including, but not limited to, volatile and non-volatile computer memory or storage devices such as a hard disk, floppy disk, USB drive, DVD, CD, media cards, register memory, processor caches, random access memory (RAM), and the like.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

The systems and processes discussed herein are intended to be illustrative and not limiting. One skilled in the art would appreciate that the actions of the processes discussed herein may be omitted, modified, combined, and/or rearranged, and any additional actions may be performed without departing from the scope of the invention. More generally, the disclosure herein is meant to provide examples and is not limiting. Only the claims that follow are meant to set bounds as to what the present disclosure includes. Furthermore, it should be noted that the features and limitations described in any some embodiments may be applied to any other embodiment herein, and flowcharts or examples relating to some embodiments may be combined with any other embodiment in a suitable manner, done in different orders, or done in parallel. In addition, the methods and systems described herein may be performed in real time. It should also be noted that the methods and/or systems described herein may be applied to, or used in accordance with, other methods and/or systems.

This specification discloses embodiments, which include, but are not limited to, the following items:

Item 1. A method comprising:
receiving a mapping query;
processing the mapping query to generate an intermediate prompt;
inputting the intermediate prompt into a generative artificial intelligence system to generate intermediate output;
integrating the intermediate output and the mapping query into final output; and
generating the final output for output on a device.

Item 2. The method of item 1, wherein the processing the mapping query to generate the intermediate prompt includes determining whether the mapping query includes a word or phrase intended to request live or updated information; and in response to determining the mapping query includes the word or phrase intended to request the live or updated information, accessing a source of live information regarding the subject.

Item 3. The method of item 1, comprising:
receiving the mapping query including a request for a live street view at an address.

Item 4. The method of item 3, wherein the processing the mapping query to generate the intermediate prompt includes accessing a source of live information regarding the address.

Item 5. The method of item 3, comprising:
accessing an image at the address;
determining a date and/or a time of the image at the address;
identifying an object in the image at the address;
modeling a change in a condition of the object from the date and/or the time of the image at the address to a current date and/or a current time; and
appending the final output to include the modeled change in the condition of the object from the date and/or the time of the image at the address to a current date and/or a current time.

Item 6. The method of item 5, comprising:
identifying a shadow cast by the object; and
determining a size of the object based on the shadow.

Item 7. The method of item 2, comprising:
receiving a request for a map at a location, wherein the subject includes the map and the location,
wherein the processing the mapping query to generate the intermediate prompt includes accessing a source of live information regarding the location.

Item 8. The method of item 2, comprising:
receiving a request for a place of business at a location, wherein the subject includes the place of business and the location,
wherein the processing the mapping query to generate the intermediate prompt includes accessing a source of live information regarding the business and/or the location.

Item 9. The method of item 1, comprising:
receiving a request for driving instructions from a current location to a destination address;
determining a route corresponding to the driving instructions from the current location to the destination address;
pre-processing enhanced information for at least one location, point of interest, or data point along the route; and
appending the final output to include the pre-processed enhanced information in real time while the device moves along the route.

Item 10. The method of item 1, wherein the intermediate output includes at least one of a map, map data, route mapping information, mapping application output, a photo from a tax record, a photo from an online source, a street view, a past location of a device, a current location of the device, a predicted future location of the device, live information, live traffic information, live weather information, information about a live event, a user-provided image, user-generated information, a user selection, a user search query, or a user selection of a zoom level of a map.

Item 11. The method of item 1, comprising:
integrating the intermediate output and the mapping query into final output including generating a sequence of images for video.

Item 12. The method of item 12, comprising:
in response to detecting a constraint in available bandwidth, increasing an encoding efficiency.

Item 13. The method of item 12, comprising:
increasing the encoding efficiency by minimizing a difference from one frame to another frame including an adjustment based on a level of motion parallax between the one frame and the another frame.

Item 14. A method comprising:
receiving a mapping query;
receiving a user preference;
accessing a map from a mapping application based at least on the mapping query;
generating, utilizing a generative artificial intelligence (AI) model, a prompt based on at least one of the mapping query, the user preference, or the map from the mapping application;
generating, utilizing a generative AI content generator, content based on the at least one of the mapping query, the user preference, or the map from the mapping application;
generating a map layer update in a format suitable for the map from the mapping application based on the generated content; and
modifying the map accessed from the mapping application based on the generated map layer update.

Item 15. The method of item 14, comprising:
determining whether the mapping query includes a word or phrase intended to request live or updated information; and
in response to determining the mapping query includes the word or phrase intended to request the live or updated information, accessing a source of live information regarding the subject.

Item 16. The method of item 14, comprising:
receiving the mapping query including a request for a live street view at an address.

Item 17. The method of item 16, comprising:
in response to determining the mapping query includes the request for the live street view at the address, accessing a source of live information regarding the address.

Item 18. The method of item 16, comprising:
accessing an image at the address;
determining a date and/or a time of the image at the address;
identifying an object in the image at the address;
modeling a change in a condition of the object from the date and/or the time of the image at the address to a current date and/or a current time; and
modifying the map to include the modeled change in the condition of the object from the date and/or the time of the image at the address to a current date and/or a current time.

Item 19. The method of item 18, comprising:
identifying a shadow cast by the object; and
determining a size of the object based on the shadow.

Item 20. The method of item 15, comprising:
receiving the mapping query including a request for a map at a location;
accessing a source of live information regarding the location; and
modifying the map accessed from the mapping application based on the generated map layer update and information from the source of live information regarding the location.

Item 21. A system comprising:
a generative artificial intelligence system;
a device; and
circuitry configured to:
   receive a mapping query;
   process the mapping query to generate an intermediate prompt;
   input the intermediate prompt into the generative artificial intelligence system to generate intermediate output;
   integrate the intermediate output and the mapping query into final output; and
   generate the final output for output on the device.

Item 22. The system of item 21, wherein the circuitry configured to process the mapping query to generate the intermediate prompt is configured to determine whether the mapping query includes a word or phrase intended to request live or updated information; and in response to determining the mapping query includes the word or phrase intended to request the live or updated information, access a source of live information regarding the subject.

Item 23. The system of item 21, wherein the circuitry configured to receive the mapping query is configured to receive a request for a live street view at an address.

Item 24. The system of item 23, wherein the circuitry configured to process the mapping query to generate the intermediate prompt is configured to access a source of live information regarding the address.

Item 25. The system of item 23, wherein the circuitry is configured to:
access an image at the address;
determine a date and/or a time of the image at the address;
identify an object in the image at the address;
model a change in a condition of the object from the date and/or the time of the image at the address to a current date and/or a current time; and
append the final output to include the modeled change in the condition of the object from the date and/or the time of the image at the address to a current date and/or a current time.

Item 26. The system of item 25, wherein the circuitry is configured to:
identify a shadow cast by the object; and
determine a size of the object based on the shadow.

Item 27. The system of item 22, wherein the circuitry is configured to:
receive a request for a map at a location, wherein the subject includes the map and the location, and
the circuitry configured to process the mapping query to generate the intermediate prompt is configured to access a source of live information regarding the location.

Item 28. The system of item 22, wherein the circuitry is configured to:
receive a request for a place of business at a location, wherein the subject includes the place of business and the location, and
the circuitry configured to process the mapping query to generate the intermediate prompt is configured to access a source of live information regarding the business and/or the location.

Item 29. The system of item 21, wherein the circuitry is configured to:
receive a request for driving instructions from a current location to a destination address;
determine a route corresponding to the driving instructions from the current location to the destination address;
pre-process enhanced information for at least one location, point of interest, or data point along the route; and
append the final output to include the pre-processed enhanced information in real time while the device moves along the route.

Item 30. The system of item 21, wherein the intermediate output includes at least one of a map, map data, route mapping information, mapping application output, a photo from a tax record, a photo from an online source, a street view, a past location of a device, a current location of the device, a predicted future location of the device, live information, live traffic information, live weather information, information about a live event, a user-provided image, user-generated information, a user selection, a user search query, or a user selection of a zoom level of a map.

Item 31. The system of item 21, wherein the circuitry is configured to:
integrate the intermediate output and the mapping query into final output including generating a sequence of images for video.

Item 32. The system of item 32, wherein the circuitry is configured to:
in response to detecting a constraint in available bandwidth, increase an encoding efficiency.

Item 33. The system of item 32, wherein the circuitry is configured to:
increase the encoding efficiency by minimizing a difference from one frame to another frame including an adjustment based on a level of motion parallax between the one frame and the another frame.

Item 34. A system comprising:
a generative artificial intelligence (AI) model;
a generative AI content generator; and
circuitry configured to:
   receive a mapping query;
   receive a user preference;
   access a map from a mapping application based at least on the mapping query;
   generate, utilizing the generative AI model, a prompt based on at least one of the mapping query, the user preference, or the map from the mapping application;
   generate, utilizing the generative AI content generator, content based on the at least one of the mapping query, the user preference, or the map from the mapping application;
   generate a map layer update in a format suitable for the map from the mapping application based on the generated content; and
   modify the map accessed from the mapping application based on the generated map layer update.

Item 35. The system of item 34, wherein the circuitry is configured to:
determine whether the mapping query includes a word or phrase intended to request live or updated information; and
in response to determining the mapping query includes the word or phrase intended to request the live or updated information, access a source of live information regarding the subject.

Item 36. The system of item 34, wherein the circuitry is configured to:
receive the mapping query including a request for a live street view at an address.

Item 37. The system of item 36, wherein the circuitry is configured to:
in response to determining the mapping query includes the request for the live street view at the address, access a source of live information regarding the address.

Item 38. The system of item 36, wherein the circuitry is configured to:
access an image at the address;
determine a date and/or a time of the image at the address;
identify an object in the image at the address;
model a change in a condition of the object from the date and/or the time of the image at the address to a current date and/or a current time; and
modify the map to include the modeled change in the condition of the object from the date and/or the time of the image at the address to a current date and/or a current time.

Item 39. The system of item 38, wherein the circuitry is configured to:
identify a shadow cast by the object; and
determine a size of the object based on the shadow.

Item 40. The system of item 35, wherein the circuitry is configured to:
receive the mapping query including a request for a map at a location;
access a source of live information regarding the location; and
modify the map accessed from the mapping application based on the generated map layer update and information from the source of live information regarding the location.

Item 41. A device comprising:
means for receiving a mapping query;
means for processing the mapping query to generate an intermediate prompt;
means for inputting the intermediate prompt into a generative artificial intelligence system to generate intermediate output;
means for integrating the intermediate output and the mapping query into final output; and
means for generating the final output for output on a device.

Item 42. The device of item 41, wherein the means for processing the mapping query to generate the intermediate prompt includes means for determining whether the mapping query includes a word or phrase intended to request live or updated information; and in response to determining the mapping query includes the word or phrase intended to request the live or updated information, accessing means for accessing a source of live information regarding the subject.

Item 43. The device of item 41, comprising:
means for receiving the mapping query including a request for a live street view at an address.

Item 44. The device of item 43, wherein the means for processing the mapping query to generate the intermediate prompt includes means for accessing a source of live information regarding the address.

Item 45. The device of item 43, comprising:
means for accessing an image at the address;
means for determining a date and/or a time of the image at the address;
means for identifying an object in the image at the address;
means for modeling a change in a condition of the object from the date and/or the time of the image at the address to a current date and/or a current time; and
means for appending the final output to include the modeled change in the condition of the object from the date and/or the time of the image at the address to a current date and/or a current time.

Item 46. The device of item 45, comprising:
means for identifying a shadow cast by the object; and
means for determining a size of the object based on the shadow.

Item 47. The device of item 42, comprising:
means for receiving a request for a map at a location, wherein the subject includes the map and the location,
wherein the means for processing the mapping query to generate the intermediate prompt includes means for accessing a source of live information regarding the location.

Item 48. The device of item 42, comprising:
means for receiving a request for a place of business at a location, wherein the subject includes the place of business and the location,
wherein the means for processing the mapping query to generate the intermediate prompt includes means for accessing a source of live information regarding the business and/or the location.

Item 49. The device of item 41, comprising:
means for receiving a request for driving instructions from a current location to a destination address;
means for determining a route corresponding to the driving instructions from the current location to the destination address;
means for pre-processing enhanced information for at least one location, point of interest, or data point along the route; and
means for appending the final output to include the pre-processed enhanced information in real time while the device moves along the route.

Item 50. The device of item 41, wherein the intermediate output includes at least one of a map, map data, route mapping information, mapping application output, a photo from a tax record, a photo from an online source, a street view, a past location of a device, a current location of the device, a predicted future location of the device, live information, live traffic information, live weather information, information about a live event, a user-provided image, user-generated information, a user selection, a user search query, or a user selection of a zoom level of a map.

Item 51. The device of item 41, comprising:
means for integrating the intermediate output and the mapping query into final output including generating a sequence of images for video.

Item 52. The device of item 52, comprising:
means for, in response to detecting a constraint in available bandwidth, increasing an encoding efficiency.

Item 53. The device of item 52, comprising:
means for increasing the encoding efficiency by minimizing a difference from one frame to another frame including an adjustment based on a level of motion parallax between the one frame and the another frame.

Item 54. A device comprising:
means for receiving a mapping query;
means for receiving a user preference;
means for accessing a map from a mapping application based at least on the mapping query;
means for generating, utilizing a generative artificial intelligence (AI) model, a prompt based on at least one of the mapping query, the user preference, or the map from the mapping application;
means for generating, utilizing a generative AI content generator, content based on the at least one of the mapping query, the user preference, or the map from the mapping application;
means for generating a map layer update in a format suitable for the map from the mapping application based on the generated content; and
means for modifying the map accessed from the mapping application based on the generated map layer update.

Item 55. The device of item 54, comprising:
means for determining whether the mapping query includes a word or phrase intended to request live or updated information; and
in response to determining the mapping query includes the word or phrase intended to request the live or updated information, accessing means for accessing a source of live information regarding the subject.

Item 56. The device of item 54, comprising:
means for receiving the mapping query including a request for a live street view at an address.

Item 57. The device of item 56, comprising:
means for, in response to determining the mapping query includes the request for the live street view at the address, accessing a source of live information regarding the address.

Item 58. The device of item 56, comprising:
means for accessing an image at the address;
means for determining a date and/or a time of the image at the address;
means for identifying an object in the image at the address;
means for modeling a change in a condition of the object from the date and/or the time of the image at the address to a current date and/or a current time; and
means for modifying the map to include the modeled change in the condition of the object from the date and/or the time of the image at the address to a current date and/or a current time.

Item 59. The device of item 58, comprising:
means for identifying a shadow cast by the object; and
means for determining a size of the object based on the shadow.

Item 60. The device of item 55, comprising:
means for receiving the mapping query including a request for a map at a location;
means for accessing a source of live information regarding the location; and
means for modifying the map accessed from the mapping application based on the generated map layer update and information from the source of live information regarding the location.

Item 61. A non-transitory, computer-readable medium having non-transitory, computer-readable instructions encoded thereon, that, when executed, perform:
receiving a mapping query;
processing the mapping query to generate an intermediate prompt;
inputting the intermediate prompt into a generative artificial intelligence system to generate intermediate output;
integrating the intermediate output and the mapping query into final output; and
generating the final output for output on a device.

Item 62. The non-transitory, computer-readable medium of item 61, wherein the processing the mapping query to generate the intermediate prompt includes determining whether the mapping query includes a word or phrase intended to request live or updated information; and in response to determining the mapping query includes the word or phrase intended to request the live or updated information, accessing a source of live information regarding the subject.

Item 63. The non-transitory, computer-readable medium of item 61, having non-transitory, computer-readable instructions encoded thereon, that, when executed, perform:
receiving the mapping query including a request for a live street view at an address.

Item 64. The non-transitory, computer-readable medium of item 63, wherein the processing the mapping query to generate the intermediate prompt includes accessing a source of live information regarding the address.

Item 65. The non-transitory, computer-readable medium of item 63, having non-transitory, computer-readable instructions encoded thereon, that, when executed, perform: accessing an image at the address;
determining a date and/or a time of the image at the address;
identifying an object in the image at the address;
modeling a change in a condition of the object from the date and/or the time of the image at the address to a current date and/or a current time; and
appending the final output to include the modeled change in the condition of the object from the date and/or the time of the image at the address to a current date and/or a current time.

Item 66. The non-transitory, computer-readable medium of item 65, having non-transitory, computer-readable instructions encoded thereon, that, when executed, perform:
identifying a shadow cast by the object; and
determining a size of the object based on the shadow.

Item 67. The non-transitory, computer-readable medium of item 62, having non-transitory, computer-readable instructions encoded thereon, that, when executed, perform:
receiving a request for a map at a location, wherein the subject includes the map and the location,
wherein the processing the mapping query to generate the intermediate prompt includes accessing a source of live information regarding the location.

Item 68. The non-transitory, computer-readable medium of item 62, having non-transitory, computer-readable instructions encoded thereon, that, when executed, perform:
receiving a request for a place of business at a location, wherein the subject includes the place of business and the location,
wherein the processing the mapping query to generate the intermediate prompt includes accessing a source of live information regarding the business and/or the location.

Item 69. The non-transitory, computer-readable medium of item 61, having non-transitory, computer-readable instructions encoded thereon, that, when executed, perform:
receiving a request for driving instructions from a current location to a destination address;
determining a route corresponding to the driving instructions from the current location to the destination address;
pre-processing enhanced information for at least one location, point of interest, or data point along the route; and
appending the final output to include the pre-processed enhanced information in real time while the device moves along the route.

Item 70. The non-transitory, computer-readable medium of item 61, wherein the intermediate output includes at least one of a map, map data, route mapping information, mapping application output, a photo from a tax record, a photo from an online source, a street view, a past location of a device, a current location of the device, a predicted future location of the device, live information, live traffic information, live weather information, information about a live event, a user-provided image, user-generated information, a user selection, a user search query, or a user selection of a zoom level of a map.

Item 71. The non-transitory, computer-readable medium of item 61, having non-transitory, computer-readable instructions encoded thereon, that, when executed, perform:
integrating the intermediate output and the mapping query into final output including generating a sequence of images for video.

Item 72. The non-transitory, computer-readable medium of item 71, having non-transitory, computer-readable instructions encoded thereon, that, when executed, perform:
in response to detecting a constraint in available bandwidth, increasing an encoding efficiency.

Item 73. The non-transitory, computer-readable medium of item 72, having non-transitory, computer-readable instructions encoded thereon, that, when executed, perform:
increasing the encoding efficiency by minimizing a difference from one frame to another frame including an adjustment based on a level of motion parallax between the one frame and the another frame.

Item 74. A non-transitory, computer-readable medium having non-transitory, computer-readable instructions encoded thereon, that, when executed, perform:
receiving a mapping query;
receiving a user preference;
accessing a map from a mapping application based at least on the mapping query;
generating, utilizing a generative artificial intelligence (AI) model, a prompt based on at least one of the mapping query, the user preference, or the map from the mapping application;
generating, utilizing a generative AI content generator, content based on the at least one of the mapping query, the user preference, or the map from the mapping application;
generating a map layer update in a format suitable for the map from the mapping application based on the generated content; and
modifying the map accessed from the mapping application based on the generated map layer update.

Item 75. The non-transitory, computer-readable medium of item 74, having non-transitory, computer-readable instructions encoded thereon, that, when executed, perform:
determining whether the mapping query includes a word or phrase intended to request live or updated information; and
in response to determining the mapping query includes the word or phrase intended to request the live or updated information, accessing a source of live information regarding the subject.

Item 76. The non-transitory, computer-readable medium of item 74, having non-transitory, computer-readable instructions encoded thereon, that, when executed, perform:
receiving the mapping query including a request for a live street view at an address.

Item 77. The non-transitory, computer-readable medium of item 76, having non-transitory, computer-readable instructions encoded thereon, that, when executed, perform:
in response to determining the mapping query includes the request for the live street view at the address, accessing a source of live information regarding the address.

Item 78. The non-transitory, computer-readable medium of item 76, having non-transitory, computer-readable instructions encoded thereon, that, when executed, perform:
accessing an image at the address;
determining a date and/or a time of the image at the address;
identifying an object in the image at the address;
modeling a change in a condition of the object from the date and/or the time of the image at the address to a current date and/or a current time; and
modifying the map to include the modeled change in the condition of the object from the date and/or the time of the image at the address to a current date and/or a current time.

Item 79. The non-transitory, computer-readable medium of item 78, having non-transitory, computer-readable instructions encoded thereon, that, when executed, perform:
identifying a shadow cast by the object; and
determining a size of the object based on the shadow.

Item 80. The non-transitory, computer-readable medium of item 75, having non-transitory, computer-readable instructions encoded thereon, that, when executed, perform:
receiving the mapping query including a request for a map at a location;
accessing a source of live information regarding the location; and
modifying the map accessed from the mapping application based on the generated map layer update and information from the source of live information regarding the location.

Item 81. A method comprising:
receiving, using control circuitry, a mapping query;
processing the mapping query to generate an intermediate prompt;
inputting the intermediate prompt into a generative artificial intelligence system to generate intermediate output;
integrating the intermediate output and the mapping query into final output; and
generating the final output for output on a device.

Item 82. The method of item 81, wherein the processing the mapping query to generate the intermediate prompt includes determining whether the mapping query includes a word or phrase intended to request live or updated information; and in response to determining the mapping query includes the word or phrase intended to request the live or updated information, accessing a source of live information regarding the subject.

Item 83. The method of any of items 81 or 82, comprising:
receiving the mapping query including a request for a live street view at an address.

Item 84. The method of item 83, wherein the processing the mapping query to generate the intermediate prompt includes accessing a source of live information regarding the address.

Item 85. The method of any of items 83 or 84, comprising:
accessing an image at the address;
determining a date and/or a time of the image at the address;
identifying an object in the image at the address;
modeling a change in a condition of the object from the date and/or the time of the image at the address to a current date and/or a current time; and
appending the final output to include the modeled change in the condition of the object from the date and/or the time of the image at the address to a current date and/or a current time.

Item 86. The method of item 85, comprising:
identifying a shadow cast by the object; and
determining a size of the object based on the shadow.

Item 87. The method of any of items 82-86, comprising:
receiving a request for a map at a location, wherein the subject includes the map and the location,
wherein the processing the mapping query to generate the intermediate prompt includes accessing a source of live information regarding the location.

Item 88. The method of any of items 82-87, comprising:
receiving a request for a place of business at a location, wherein the subject includes the place of business and the location,
wherein the processing the mapping query to generate the intermediate prompt includes accessing a source of live information regarding the business and/or the location.

Item 89. The method of any of items 81-88, comprising:
receiving a request for driving instructions from a current location to a destination address;
determining a route corresponding to the driving instructions from the current location to the destination address;
pre-processing enhanced information for at least one location, point of interest, or data point along the route; and
appending the final output to include the pre-processed enhanced information in real time while the device moves along the route.

Item 90. The method of any of items 81-88, wherein the intermediate output includes at least one of a map, map data, route mapping information, mapping application output, a photo from a tax record, a photo from an online source, a street view, a past location of a device, a current location of the device, a predicted future location of the device, live information, live traffic information, live weather information, information about a live event, a user-provided image, user-generated information, a user selection, a user search query, or a user selection of a zoom level of a map.

Item 91. The method of any of items 81-88, comprising:
integrating the intermediate output and the mapping query into final output including generating a sequence of images for video.

Item 92. The method of any of items 81-88, comprising:
in response to detecting a constraint in available bandwidth, increasing an encoding efficiency.

Item 93. The method of any of items 81-88, comprising:
increasing the encoding efficiency by minimizing a difference from one frame to another frame including an adjustment based on a level of motion parallax between the one frame and the another frame.

Item 94. A method comprising:
receiving, using control circuitry, a mapping query;
receiving a user preference;
accessing a map from a mapping application based at least on the mapping query;
generating, utilizing a generative artificial intelligence (AI) model, a prompt based on at least one of the mapping query, the user preference, or the map from the mapping application;
generating, utilizing a generative AI content generator, content based on the at least one of the mapping query, the user preference, or the map from the mapping application;
generating a map layer update in a format suitable for the map from the mapping application based on the generated content; and
modifying the map accessed from the mapping application based on the generated map layer update.

Item 95. The method of item 94, comprising:
determining whether the mapping query includes a word or phrase intended to request live or updated information; and
in response to determining the mapping query includes the word or phrase intended to request the live or updated information, accessing a source of live information regarding the subject.

Item 96. The method of any of items 94 or 95, comprising:
receiving the mapping query including a request for a live street view at an address.

Item 97. The method of item 96, comprising:
in response to determining the mapping query includes the request for the live street view at the address, accessing a source of live information regarding the address.

Item 98. The method of any of items 96 or 97, comprising:
accessing an image at the address;
determining a date and/or a time of the image at the address;
identifying an object in the image at the address;
modeling a change in a condition of the object from the date and/or the time of the image at the address to a current date and/or a current time; and
modifying the map to include the modeled change in the condition of the object from the date and/or the time of the image at the address to a current date and/or a current time.

Item 99. The method of item 98, comprising:
identifying a shadow cast by the object; and
determining a size of the object based on the shadow.

Item 100. The method of any of items 95-99, comprising:
receiving the mapping query including a request for a map at a location;
accessing a source of live information regarding the location; and
modifying the map accessed from the mapping application based on the generated map layer update and information from the source of live information regarding the location.

This description is to be taken only by way of example and not to otherwise limit the scope of the embodiments herein. Therefore, it is the object of the appended claims to cover all such variations and modifications as come within the true spirit and scope of the embodiments herein.

1. A method comprising:
receiving a mapping query;
processing the mapping query to generate an intermediate prompt;
inputting the intermediate prompt into a generative artificial intelligence system to generate intermediate output;
integrating the intermediate output and the mapping query into final output; and
generating the final output for output on a device.

2. The method of claim 1, wherein the processing the mapping query to generate the intermediate prompt includes determining whether the mapping query includes a word or phrase intended to request live or updated information; and in response to determining the mapping query includes the word or phrase intended to request the live or updated information, accessing a source of live information regarding the subject.

3. The method of claim 1, comprising:
receiving the mapping query including a request for a live street view at an address.

4. The method of claim 3, wherein the processing the mapping query to generate the intermediate prompt includes accessing a source of live information regarding the address.

5. The method of claim 3, comprising:
accessing an image at the address;
determining a date and/or a time of the image at the address;
identifying an object in the image at the address;
modeling a change in a condition of the object from the date and/or the time of the image at the address to a current date and/or a current time; and
appending the final output to include the modeled change in the condition of the object from the date and/or the time of the image at the address to a current date and/or a current time.

6. The method of claim 5, comprising:
identifying a shadow cast by the object; and
determining a size of the object based on the shadow.

7. The method of claim 2, comprising:
receiving a request for a map at a location, wherein the subject includes the map and the location,
wherein the processing the mapping query to generate the intermediate prompt includes accessing a source of live information regarding the location.

8. The method of claim 2, comprising:
receiving a request for a place of business at a location, wherein the subject includes the place of business and the location,
wherein the processing the mapping query to generate the intermediate prompt includes accessing a source of live information regarding the business and/or the location.

9. The method of claim 1, comprising:
receiving a request for driving instructions from a current location to a destination address;
determining a route corresponding to the driving instructions from the current location to the destination address;
pre-processing enhanced information for at least one location, point of interest, or data point along the route; and
appending the final output to include the pre-processed enhanced information in real time while the device moves along the route.

10. The method of claim 1, wherein the intermediate output includes at least one of a map, map data, route mapping information, mapping application output, a photo from a tax record, a photo from an online source, a street view, a past location of a device, a current location of the device, a predicted future location of the device, live information, live traffic information, live weather information, information about a live event, a user-provided image, user-generated information, a user selection, a user search query, or a user selection of a zoom level of a map.

11.-13. (canceled)

14. A method comprising:
receiving a mapping query;
receiving a user preference;
accessing a map from a mapping application based at least on the mapping query;
generating, utilizing a generative artificial intelligence (AI) model, a prompt based on at least one of the mapping query, the user preference, or the map from the mapping application;
generating, utilizing a generative AI content generator, content based on the at least one of the mapping query, the user preference, or the map from the mapping application;
generating a map layer update in a format suitable for the map from the mapping application based on the generated content; and
modifying the map accessed from the mapping application based on the generated map layer update.

15.-20. (canceled)

21. A system comprising:
a generative artificial intelligence system;
a device; and
circuitry configured to:
receive a mapping query;
process the mapping query to generate an intermediate prompt;
input the intermediate prompt into the generative artificial intelligence system to generate intermediate output;
integrate the intermediate output and the mapping query into final output; and
generate the final output for output on the device.

22. The system of claim 21, wherein the circuitry configured to process the mapping query to generate the intermediate prompt is configured to determine whether the mapping query includes a word or phrase intended to request live or updated information; and in response to determining the mapping query includes the word or phrase intended to request the live or updated information, access a source of live information regarding the subject.

23. The system of claim 21, wherein the circuitry configured to receive the mapping query is configured to receive a request for a live street view at an address.

24. The system of claim 23, wherein the circuitry configured to process the mapping query to generate the intermediate prompt is configured to access a source of live information regarding the address.

25. The system of claim 23, wherein the circuitry is configured to:
access an image at the address;
determine a date and/or a time of the image at the address;
identify an object in the image at the address;
model a change in a condition of the object from the date and/or the time of the image at the address to a current date and/or a current time; and
append the final output to include the modeled change in the condition of the object from the date and/or the time of the image at the address to a current date and/or a current time.

26. The system of claim 25, wherein the circuitry is configured to:
identify a shadow cast by the object; and
determine a size of the object based on the shadow.

27. The system of claim 22, wherein the circuitry is configured to:
receive a request for a map at a location, wherein the subject includes the map and the location, and
the circuitry configured to process the mapping query to generate the intermediate prompt is configured to access a source of live information regarding the location.

28. The system of claim 22, wherein the circuitry is configured to:
receive a request for a place of business at a location, wherein the subject includes the place of business and the location, and
the circuitry configured to process the mapping query to generate the intermediate prompt is configured to access a source of live information regarding the business and/or the location.

29. The system of claim 21, wherein the circuitry is configured to:
receive a request for driving instructions from a current location to a destination address;
determine a route corresponding to the driving instructions from the current location to the destination address;
pre-process enhanced information for at least one location, point of interest, or data point along the route; and
append the final output to include the pre-processed enhanced information in real time while the device moves along the route.

30.-100. (canceled)
